(19) United States
(12) Patent Application Publication
(10) Pub. No.: US 2023/0184641 A1
(43) Pub. Date: Jun. 15, 2023

(54) METHOD AND APPARATUS FOR PROCESSING ARCHIVED TISSUE SAMPLES

(71) Applicant: S2 Genomics, Inc., Livermore, CA (US)

(72) Inventors: Stevan Bogdan Jovanovich, Livermore, CA (US); John Bashkin, Fremont, CA (US); Nathan Pereira, Pleasanton, CA (US)

(21) Appl. No.: 17/926,085

(22) PCT Filed: May 18, 2021
(86) PCT No.: PCT/US21/33001

§ 371 Date: Nov. 17, 2022

Related U.S. Application Data
(60) Provisional application No. 63/026,673, filed on May 18, 2020.

(51) Int. Cl. G01N 1/36; B01L 7/00; B01L 3/00

(52) U.S. Cl. CPC G01N 1/36; B01L 7/52; B01L 3/502715; G01N 2001/2866

(57) ABSTRACT

A system, methods, and apparatus are described to collect and prepare cells, nuclei, subcellular components, and biomolecules from specimens including FFPE and OCT preserved tissues. The system can perform deparaffinization, rehydration, enzymatic and/or chemical and physical disruption of the FFPE tissue, or residue removal of the OCT tissue, to dissociate it into a single cell or nuclei suspension.

### CROSS REFERENCE TO RELATED APPLICATIONS

This application claims the benefit of the priority date of provisional patent application 63/026,673, filed May 18, 2020 (Jovanovich, Bashkin and Pereira, “Method and Apparatus for Processing Archived Tissue Samples”). It is related to provisional patent application, 62/427,150, filed Nov. 29, 2016, (Jovanovich, Zaugg, Chear, Wagner, Kernen, and McIntosh, “Method and Apparatus for Producing Single Cell Suspensions from Tissue and Other Samples), the contents of which are incorporated herein in their entirety and the benefit of the priority date of provisional patent application, 62/526,267, filed Jul. 28, 2017, (Jovanovich, Chear, McIntosh, Pereira, and Zaugg, “Method and Apparatus for Producing Single Cell Suspensions and Next Generation Sequencing Libraries for bulk DNA and Single-Cells from Tissue and Other Samples”), and the benefit of the priority date of patent application PCT/US2017/063811 filed Nov. 29, 2017 (Jovanovich, Chear, McIntosh, Pereira, and Zaugg, “Method and Apparatus for Processing Tissue Samples”); and the benefit of the priority date of patent application PCT/US19/35097 filed Jun. 1, 2019 (Jovanovich, Chear, Leisz, Eberhart, and Bashkin, “Method and Apparatus for Processing Tissue Samples”); the contents of all are incorporated herein in their entirety.

### BACKGROUND OF THE INVENTION

### Field of Invention

This invention relates to the field of sample preparation from biological materials. More specifically, the invention relates to the processing of formalin fixed paraffiin preserved solid tissues into single nuclei for bioanalysis.

### Description of Related Art

The estimated 400 million(Sah S, Chen L, Houghton J, et al. Functional DNA quantification guides accurate next-generation sequencing mutation detection in formalin-fixed, paraffin-embedded tumor biopsies. Genome Med 2013; 5:77.) to 1 billion (Blow N. Tissue preparation: tissue issues. Nature 2007:448:959-63.) Formaldehyde Fixed Paraffin Embedded (FFPE) samples archived in biorepositories are a treasure-trove of invaluable preserved clinical samples from diseased and normal tissues. Retrospective studies retrieving the genomic information stored in these samples are helping elucidate the interplay of human cellular responses to diseases, aging, and the environment. Bulk DNA or RNA sequences (i.e., from a population of cells) are now being analyzed by genomic methods including Next Generation Sequencing (NGS). However, bulk measurements mask crucial information by averaging signals over a large number of cells. Single-cell resolution is needed to precisely define heterogeneity in cellular states and relate genomic variations to development and disease (Trapnell C. (2015). Defining cell types and states with single-cell genomics. Genome research, 25(10), 1491-1498. https://doi.org/10.1101/gr.190595.115.). This invention details how to create a system to automate the processing of FFPE tissue to recover intact nuclei suspensions for downstream single nuclei sequencing.

With the advent of next generation sequencing, methods have been developed to isolate bulk nucleic acids from FFPE samples by reversing the tissue preservation before nucleic acids extraction. The quality of the recovered nucleic acids varies depending on the sample age, details of the FFPE process used, and nucleic acids isolation method, and is generally lower compared to nucleic acids extracted from fresh/flash frozen tissues. Specifically, the formaldehyde in formalin creates chemical crosslinks between proteins, and between proteins and nucleic acids. Some of these crosslinks are reversible with chemicals, enzymatic treatment, or heat but significantly affect the recovery and quality of DNA, RNA, and proteins for downstream molecular analyses. In addition, these bulk sequencing results average the information on the cellular states from many cells and do not reveal single cell or nuclei information.

Another preservation method which for the thin sectioning of fresh tissue is preservation in Optimum Cutting Temperature compound (OCT). OCT freezing preserves the morphology of the tissue. OCT blocks are thin sectioned for histology and other analysis.

Single-cell sequencing has rapidly transformed the knowledge base of cellular heterogeneity, revealing new cell types and subtypes, and increasing our understanding of tissue function, cellular organization, and cell-cell interactions. A number of genomic applications have been developed and commercialized including single cell (scRNA-Seq) and single nuclei (snRNA-Seq) (Grindberg R V, Yee-Greenbaum J L, McConnell M J, Novotny M, O'Shaughnessy A L, Lambert G M, Araúzo-Bravo M J, Lee J, Fishman M, Robbins G E, Lin X, Venepally P, Badger J H, Galbraith D W, Gage F H, Lasken R S. RNA-sequencing from single nuclei. Proc Natl Acad Sci USA. 2013 Dec. 3; 110(49):19802-7. doi: 10.1073/pnas.1319700110. Epub 2013 Nov. 18.; Krishnaswami S R, Grindberg R V, Novotny M, Venepally P, Lacar B, Bhutani K, Linker S B, Pham S, Erwin J A, Miller J A, Hodge R, McCarthy J K, Kelder M, McCorrison J, Aevermann B D, Fuertes F D, Scheuermann R H, Lee J, Lein E S, Schork N, McConnell M J, Gage F H, Lasken R S. Using single nuclei for RNA-seq to capture the transcriptome of postmortem neurons. Nat Protoc. 2016 Mar.: 11(3):499-524. doi: 10.1038/nprot.2016.015. PMID: 26890679; Habib N, Li Y, Heidenreich M, Swiech L, Avraham-Davidi I, Trombetta J J, Hession C, Zhang F, Regev A, Div-Seq: Single-nucleus RNA-Seq reveals dynamics of rare adult newborn neurons. Science. 2016 Aug. 26; 353(6302):925-8. doi: 10.1126/science.aad7038. Epub 2016 Jul. 28.) transcriptome sequencing, single cell DNA sequencing (DNA-Seq)(Eastburn D J., Y Huang, M Pellegrino, A Sciambi, L Ptáček, and A R Abate. Microfluidic droplet enrichment for targeted sequencing. Nucleic Acids Res. 2015 Jul. 27; 43(13): e86. PMID: 25873629), chromatin accessibility (ATAC-Seq) assays (Buenrostro, Jason D.; Giresi, Paul G.; Zaba, Lisa C.; Chang, Howard Y.; Greenleaf, William J. (2013-12-01). “Transposition of native chromatin for fast and sensitive epigenomic profiling of open chromatin, DNA-binding proteins and nucleosome position”. Nature Methods. 10 (12): 1213-1218. doi:10.1038/nmeth.2688. ISSN 1548-7105. PMC 3959825. PMID 24097267), and combined genomic and proteomic analysis (CITE-Seq) (Stoeckius M, C Hafemeister, W Stephenson, B Houck-Loomis, P K Chattopadhyay, H. Swerdlow, R. Satija, and P. Smibert. Simultaneous epitope and transcriptome measurement in single cells. Nature Methods, 14: 865-868 (2017).). Single cell sequencing (Wang., Y. and N. E. Navin. Advanced and Applications of single-cell sequencing technologies. Molecular Cell. 2015·58:598-609. PMID 26000845.) is being applied to study development, brain structure and function, tumor progression and resistance, immuno-oncology, and many other areas, and is expected to advance precision medicine to the cellular level with emerging clinical applications.

Single-cell sequencing is rapidly changing the state of knowledge of cells and tissue, discovering new cell types, and increasing the understanding of the diversity of how cells and tissue function. Single-cell RNA sequencing is being applied to development, brain structure and function, tumor progression and resistance, immunogenetics, and more (Shapiro E. Biezuner T, Linnarsson S. Single-cell sequencing-based technologies will revolutionize whole-organism science. Nat Rev Genet. 2013; 14(9):618-30. PMID: 23897237). Single cell or nuclei sequencing has highlighted the complexity of cellular expression, and the large heterogeneity from cell-to-cell, and from cell type-to-cell type (Buettner F. Natarajan K N, Casale F P, Proserpio V, Scialdone A. Theis F J, Teichmann S A, Marioni J C, Stegle O. Computational analysis of cell-to-cell heterogeneity in single-cell RNA-sequencing data reveals hidden subpopulations of cells. Nat Biotechnol. 2015; 33(2):155-60. PMID: 25599176) (Wang., Y. and N. E. Navin. Advanced and Applications of single-cell sequencing technologies. Molecular Cell. 2015, 58:598-609. PMID 26000845.).

Single cell and single nuclei sequencing technology and methods using NGS are rapidly evolving. Common components are incorporation of a marker or barcode for each cell and molecule, reverse transcriptase for RNA sequencing, amplification, and pooling of sample for NGS and NNGS (collectively termed NGS) library preparation and analysis. Starting with isolated single cells in wells, barcodes for individual cells and molecules have been incorporated by reverse transcriptase template switching before pooling and polymerase chain reaction (PCR) amplification (Islam S. et. al. Genome Res. 2011: 21(7):1160-7.) (Ramsköld D. et. al. Nat Biotechnol. 2012; 30(8):777-82.) or on a barcoded poly-T primer with linear amplification (Hashimshony T. et. al. Cell Rep. 2012 Sep. 27; 2(3):666-73.) and unique molecular identifiers (Jaitin D. A. et. al. Science. 2014; 343(6172):776-9.).

Pioneering work used the power of nanodroplets to perform highly parallel processing of mRNA from single cells with reverse transcription incorporating cell and molecular barcodes from freed primers (inDrop) (Klein A. M. et. al. Cell. 2015; 161(5):1187-201.) or primers attached to paramagnetic beads (DropSeq) (Macosko E. Z. et. al. Cell. 2015; 161(5):1202-14.) and using micronozzles such as described by them or (Geng T. et. al. Anal Chem. 2014; 86(1):703-12) or others; the lysis conditions and reverse transcriptase described by (Fekete R. A. and A. Nguyen. U.S. Pat. No. 8,288,106. Oct. 16, 2012) are incorporated by reference and then references cited therein are incorporated by reference, including instrumentation, chemistry, workflows, reactions conditions, flowcell design, and other teachings. Both inDrop and DropSeq are scalable approaches have change the scale from 100s of cells previously analyzed to 1,000s and more.

A fundamental bottleneck in single cell biology has been preparing single cell suspensions from solid tissues in high yield and viability. The production of single-cells or nuclei or nucleic acids from solid and liquid tissue is usually performed manually with a number of devices used without process integration. It is laborious and requires skilled technicians or scientists, and results in variability in the quality of the single-cells, and, therefore, in the downstream libraries, analysis, and data. The multiple steps and skill required can lead to differing qualities of single cells or nuclei produced even from the same specimen. Today, the production of high quality single-cells can take months of optimization.

Different tissues, organisms, and cell types require different dissociation conditions, fragile cell types can be lost, and transcription altered (van den Brink S C, Sage F. Vértesy Á. et al. Single-cell sequencing reveals dissociation-induced gene expression in tissue subpopulations. Nat Methods. 2017; 14(10):935-936. doi. 10.1038/nmeth.4437.). Many manual protocols for dissociating different tissues exist, for example, Jungblut M., Oeltze K., Zehnter I., Hasselmann D., Bosio A. (2009). Standardized Preparation of Single-Cell Suspensions from Mouse Lung Tissue using the gentleMACS Dissociator. JoVE. 29, doi: 10.3791/1266; Stagg A J, Burke F, Hill S, Knight S C, Isolation of Mouse Spleen Dendritic Cells. Protocols, Methods in Molecular Medicine. 2001: 64: 9-22. Doi: 10.1385/1592591507.; Lancelin, W., Guerrero-Plata, A. Isolation of Mouse Lung Dendritic Cells. J. Vis. Exp. (57), e3563, 2011. DOI: 10.3791/3563; Smedsrod B, Pertoft H. Preparation of pure hepatocytes and reticuloendothelial cells in high yield from a single rat liver by means of Percoll centrifugation and selective adherence. J Leukocyte Biol. 1985: 38: 213-30.; Meyer J, Gonelle-Gispert C, Morel P, Bühler L Methods for Isolation and Purification of Murine Liver Sinusoidal Endothelial Cells: A Systematic Review. PLoS ONE 11(3) 2016: e0151945. doi:10.1371/journal.pone.0151945.; Kondo S. Scheef E A, Sheibani N, Sorenson C M. “PECAM-1 isoform-specific regulation of kidney endothelial cell migration and capillary morphogenesis”, Am J Physiol Cell Physiol 292: C2070-C2083, (2007): doi: 10.1152/ajpcell.00489.2006.; Ehler, E., Moore-Morris, T., Lange. S. Isolation and Culture of Neonatal Mouse Cardiomyocytes. J. Vis. Exp. (79), e50154, doi:10.3791/50154 (2013).; Volovitz I Shapira N, Ezer H, Gafni A, Lustgarten M, Alter T, Ben-Horin I, Barzilai O, Shahar T, Kanner A, Fried I, Veshchev I, Grossman R. Ram, Z. A non-aggressive, highly efficient, enzymatic method for dissociation of human brain-tumors and brain-tissues to viable single cells. BMC Neuroscience (2016) 17:30 doi: 10.1186/s12868-016-0262-y; F. E Dwulet and M. E. Smith, “Enzyme composition for tissue dissociation,” U.S. Pat. No. 5,952,215, Sep. 14, 1999. A combination of gentle mechanical disruption with enzymatic dissociation has been shown to produce single-cells with the highest viability and least cellular stress response (Quatromoni J G, Singhal S, Bhojnagarwala P, Hancock W W, Albelda S M, Eruslanov E. An optimized disaggregation method for human lung tumors that preserves the phenotype and function of the immune cells. J Leukoc Biol. 2015 January; 97(1):201-9. doi: 10.1189/jlb.5TA0814-373. Epub 2014 Oct. 30.).

Standardization is necessary before routine single-cell preparation can be performed, particularly in clinical settings. In addition, the length of the process and the process of dissociation can lead to the tissue and cells changing physiology such as altering their expression of RNA and proteins in response to the stresses of the procedure, accentuated by potentially long processing times.

A crucial recent insight is that cell processing methods can alter gene expression by placing cells under stress, for example, the use of protease to dissociate cells from tissue, confounding analysis of the true transcriptome (Lacar B, Linker S B, Jaeger B N, Krishnaswami S, Barron J, Kelder M, Parylak S, Paquola A, Venepally P, Novotny M, O'Connor C, Fitzpatrick C, Erwin J, Hsu J Y, Husband D, McConnell M J, Lasken R, Gage F H, Nuclear RNA-seq of single neurons reveals molecular signatures of activation. Nat Commun. 2016 Apr. 197:11022. doi: 10.1038/ncomms11022. PMID: 27090946.).

The direct dissociation of tissue into nuclei avoids many of these issues and single nuclei RNA sequencing (snRNA-Seq) can give a snapshot of gene expression (Habib N, Li Y, Heidenreich M, Swiech L, Avraham-Davidi I, Trombetta J J, Hession C, Zhang F, Regev A. Div-Seq: Single-nucleus RNA-Seq reveals dynamics of rare adult newborn neurons. Science. 2016 Aug. 26; 353(6302):925-8. doi: 10.1126/science.aad7038. Epub 2016 Jul. 28.: Grindberg R V, Yee-Greenbaum J L, McConnell M J, Novotny M, O'Shaughnessy A L, Lambert G M, Araúzo-Bravo M J, Lee J, Fishman M, Robbins G E, Lin X, Venepally P, Badger J H, Galbraith D W, Gage F H, Lasken R S. RNA-sequencing from single nuclei. Proc Natl Acad Sci USA. 2013 Dec. 3; 110(49):19802-7. doi: 10.1073/pnas.1319700110. Epub 2013 Nov. 18.).

The production of nuclei from tissue can be performed using a Dounce homogenizer in the presence of a buffer with a detergent that lyses cells but not nuclei. Nuclei can also be prepared starting from single cell suspensions (CG000124_SamplePrepDemonstratedProtocol_-_Nuclei_RevB, 10× Genomics, https://assets.contentful.com/an68im79xiti/6FhJX6yndYy0OwskGmMc8I/48c341c178feafa3ce21f53 45ed3367b/CG000124_SamplePrepDemonstratedProtocol_-_Nuclei_RevB.pdf) by addition of a lysis buffer such as 10 mM Tris-HCl, 10 mM NaCl, 3 mM MgCl2 and 0.005% Nonidet P40 in nuclease-free water and incubation for 5 min on ice before centrifugation to pellet the nuclei followed by resuspension in a resuspension buffer such as IX PBS with 1.0% BSA and 0.2 U/μl RNase Inhibitor. The nuclei may be repeatedly pelleted and resuspended to purify them or density gradients or other purification methods used. The titer and viability of the nuclei suspension is usually determined using optical imaging with a microscope and haemocytometer, or an automated instrument with viability determined using Trypan blue or fluorescent dyes.

FFPE samples are difficult to process for genomic analysis, including NGS bulk sequencing. The paraffin and formalin fixative are typically reversed by a process of deparaffinization and rehydration before binding and release from beads. This process loses all single cell information archived in the sample.

The dissociation of FFPE into single nuclei suspensions were first applied in 1989 to analyze the DNA content of tumor cells (Hedley D W. Flow cytometry using paraffin-embedded tissue: five years on. Cytometry. 1989; 10:229-41.). More recently, a novel method was developed to enrich nuclei (Juskevicius D, Dietsche T, T, Lorber, A. Rufle, C. Ruiz, U. Mickys, F. Kasniqi, S. Dimhofer, and A. Tzankov. 2014. Extracavitary primary effusion lymphoma: clinical, morphological, phenotypic and cytogenctic characterization using nuclei enrichment technique. Histopathology, 65: 693-706.) and then flow sorted the nuclei to extract genomic DNA from FFPE-preserved classical Hodgkin lymphoma tissues for targeted sequencing of genes affected in lymphomas (Juskevicius D, Jucker D, Dietsche T, et al. 2018. Novel cell enrichment technique for robust genetic analysis of archival classical Hodgkin lymphoma tissues. Lab Invest. 98(11):1487-1499. doi:10.1038/s41374-018-0096-6.). Holley et al. prepared tumor nuclei from FFPE tissues for array CGH and whole exome sequencing (Holley T, Lenkiewicz E, Evers L., et al. Deep clonal profiling of formalin fixed paraffin embedded clinical samples. PLoS One. 2012; 7(11):e50586. doi: 10.1371/journal.pone.0050586. Epub 2012 Nov. 30.). Those studies all demonstrated isolation of nuclei from FFPE samples and successful application of genomic analyses.

The dissociation of FFPE preserved tissues into nuclei for single cell genomic analyses is still in its infancy. Cooper et al. report mapping of DNase I hypersensitive sites in single cells from FFPE treated samples with carrier plasmids added during processing to counteract the low amount of DNA recovered (Cooper J, Ding Y, Song J, Zhao K. Genome-wide mapping of DNase I hypersensitive sites in rare cell populations using single-cell DNase sequencing. Nat Protoc. 2017:12(11):2342-2354. doi:10.1038/nprot.2017.099.). Martelotto et al. produced single nuclei from FFPE samples and successfully produced and analyzed single nuclei sequencing libraries (Martelotto L G, Baslan T. Kendall J, Rodgers L, Cox H, King T A, Weigelt B, Hicks J. Reis-Filho J S. Single cell sequencing analysis of formalin-fixed paraffin-embedded ductal carcinomas in situ and invasive breast cancers reveals clonal selection in the progression from in situ to invasive disease. [abstract]. In: Proceedings of the Thirty-Eighth Annual CTRC-AACR San Antonio Breast Cancer Symposium: 2015 Dec. 8-12; San Antonio, Tex. Philadelphia (Pa.): AACR; Cancer Res 2016; 76(4 Suppl):Abstract nr P2-05-01.) and Regev and colleagues (Regev, McCabe, Melnikof, et. al., Method for extracting nuclei or whole cells from formalin-fixed paraffin embedded tissues. WO 2020 077236A1, Apr. 16, 2020) reported manual methods to recover sufficient nuclei from FFPE tissue sections for single nuclei sequencing.

Robust, automated sample preparation of single cells or nuclei from FFPE samples is required to extract the single cell information captured in the preserved samples.

### BRIEF SUMMARY OF THE INVENTION

Disclosed herein is a Tissue Processing System that processes fresh, frozen, FFPE, OCT, or other samples for bioanalysis. The Tissue Processing System processes are comprised of fluidic processes to deliver different solutions to deparaffinize and rehydrate the FFPE sample; enzymatic, thermal, or chemical processes to reverse crosslinking and dissociate the tissue; chemical processes to dissociate tissue, and mechanical processes to mix solutions and mechanically disrupt the tissue. This invention enables, among other things, the implementation of a Sample Processing System that inputs FFPE samples, and processes the samples for bioanalysis and other analyses.

In a preferred embodiment, the sample or specimen is an FFPE or OCT preserved tissue specimen. The tissue can be from any source such as a human, animal, or plant tissue. Examples of tissues include, without limitation, a biopsy sample, a cellular conglomerate, an organ fragment, bone marrow, a fine needle aspirate, a core biopsy, a resection, or any other solid, semi-solid, gelatinous, frozen or fixed three dimensional or two dimensional cellular matrix of biological origin. In another embodiment the FFPE or OCT preserved tissue sample is processed to release nucleic acids which are bound to a membrane, chip surface, bead, surface, flow cell, or particle. The term specimen is used to mean samples and tissue specimens including FFPE or OCT preserved samples.

In one embodiment a Sample Processing System is used for tissue processing. A Tissue Processing System embodiment can be implemented as a flexible, extensible system that can process solid or liquid tissue and other samples into single cells, nuclei, organelles, and biomolecules with mechanical and enzymatic or chemical processes to produce single nuclei, subcellular components, and biomolecules such as macromolecules comprised of nucleic acids, comprised of DNA and RNA: proteins: carbohydrates: lipids: biomolecules with multiple types of macromolecules: metabolites; and other biological components, including natural products for bioanalysis. In some embodiments, the Tissue Processing System performs affinity or other purifications to enrich or deplete cell types, organelles such as nuclei, mitochondria, ribosomes, or other organelles, or extracellular fluids. In some embodiments the Tissue Processing System can perform NGS library preparation. In some embodiments, the Tissue Processing System processes tissue into single-nuclei libraries for sequencing including Sanger, NGS, single nuclei NGS, and other nucleic acid sequencing technologies, or proteomics, or other analytical methods.

In some embodiments the Sample Processing System can be integrated with downstream bioanalysis to create a sample-to-answer system. In a preferred embodiment of the Sample Processing System, a Tissue Processing System processing embodiment is integrated with a nucleic acid bioanalysis system to sequence nucleic acids from FFPE preserved tissues. Integrated is used to mean the workflows directly interface or in other contexts that the physical system directly interfaces or is incorporated into a system, instrument, or device. In one embodiment, the Tissue Processing System is integrated with a nucleic acid sequencer to produce a sample-to-answer system.

The Sample Processing System can have multiple subsystems and modules that perform processing or analysis. In a preferred embodiment of the Sample Processing System, one or more cartridges performs one or more steps in the processing workflow. In some embodiments the cartridges have multiple processing sites such as processing chambers that can process more than one sample. In some embodiments a cap couples mechanical disruption on the cartridge from a Physical Dissociation Subsystem. In some embodiments reagents from an Enzymatic and Chemical Dissociation Subsystem are delivered to the cartridge by a Fluidic Subsystem to regions that are used as Processing Chambers and Post-Processing Chambers to disrupt or dissociate specimen and process the cells, subcellular components, and biomolecules for bioanalysis.

The addition of fluids can be controlled by a Fluidic Subsystem with the complete system controlled by software in a Control Subsystem which can include the user interface through a device comprised of monitor, embedded display, touch screen; or through audio commands through the system or an accessory devices such as a cell phone or microphone. In some instances the Control Subsystem can include interfaces to laboratory information management systems, other instruments, databases, analysis software, email, and other applications.

In some embodiments, the amount of dissociation is monitored at intervals during the dissociation and in some instances the yield is determined during or after processing using a Measurement Subsystem. The degree of dissociation can be determined inside the main dissociation compartment and/or in a separate compartment or channel, and/or in the external instrument.

In some embodiments, cell or organelle or other imaging or labeling solutions, such as cell type specific antibodies, stains, or other reagents, can be added to the tissue or single cells or nuclei before, during, or after processing. The imaging can capture cells, subcellular structures, cell health assays of apoptosis, necrosis, or cytoxicity, or histological or other data. In some embodiments the images can be analyzed to direct the operation and workflow of the Sample Processing System through decisions trees, hash tables, machine learning, or artificial intelligence. In other embodiments the imaging or labeling solutions can contain DNA or other barcodes.

In some embodiments, single cells or nuclei in suspension or on surfaces are further processed using magnetic bead or particle technologies using a Magnetic Processing module to purify or deplete cell types, nuclei, nucleic acids, or other biomolecules.

The term singulated cells is used to mean single cells in suspension or on a surface or in a well including a microwell or nanowell such that they can be processed as single cells. The term singulated cells is also used at times to encompass single nuclei. The term nuclei suspension is also used at times to encompass single cell suspensions.

In one embodiment, the specimen is added to a cartridge which performs both physical and enzymatic dissociation of the tissue. In some embodiments the Tissue Processing System performs trituration and other physical dissociation modalities as a step or steps in the process of singulating cells. The physical dissociation modalities include passing the specimen through screens, filters, orifices, grinding, blending, sonication, smearing, bead beating, and other methods known to one skilled in the art to physically disrupt tissue to help produce single cells or nuclei or nucleic acids or other biomolecules.

In one embodiment, the Sample Processing System is an Tissue Processing System embodiment. In one embodiment, the Tissue Processing System described can input FFPE or OCT samples, or other primary or secondary samples, and output single nuclei ready for single nuclei analysis or for additional processing, e.g., to library preparation, or many other applications. In a preferred Tissue Processing System described embodiment, there is a cartridge that inputs FFPE or OCT tissue and/or other specimens and outputs a single nuclei suspension. In a preferred embodiment, there is a device that holds the input FFPE or OCT tissue to retain the tissue during some of the processing steps.

In some embodiments, the Sample Processing System, such as a Tissue Processing System embodiment, uses enzymes to assist in the process of singulating cells or nuclei including enzymes to preserve nucleic acids and prevent clumping. The enzymes are comprised of but not limited to collagenases (e.g., collagenases type I, II, III, IV, and others), elastase, trypsin, papain, tyrpLE, hyaluronidase, chymotrypsin, neutral protease, pronase, liberase, clostripain, caseinase, neutral protease (Dispase®), DNAse, protease XIV, RNase inhibitors, or other enzymes, biochemicals, or chemicals such as Triton X-100, Nonidet P40, detergents, surfactants, etc. In other embodiments, different reagents or mixtures of reagents are applied sequentially to dissociate deparaffinized, rehydrated FFPE specimens into single-cell or single nuclei suspensions. In other embodiments, reagents containing detergents or surfactants are applied to dissociate deparaffinized, rehydrated FFPE specimens into single nuclei suspensions.

In some embodiments the Tissue Processing System produces suspensions of known titers. In some embodiments the Tissue Processing System monitors the amount of singulation of a sample and adjusts the treatment time and concentration of enzymes, chemicals, mechanical disruption, or other dissociation agents by monitoring of the dissociation, for example by the production of single cells or nuclei. The monitoring can be in real time, in intervals, or endpoints or any combinations thereof.

The Tissue Processing System can in some embodiments select from sets of reagents to deparaffinize, rehydrate, reverse crosslinks, and dissociate tissue by adjusting the production of single nuclei by monitoring by the system. In some instances in real time, at intervals, or as an endpoint the titer, quality, or other attributes of the single nuclei suspensions.

The Tissue Processing System has advantages over existing technology and can produce single nuclei, or biomolecules from tissue in an automated and standardized instrument that can in some embodiments process the specimens into NGS libraries or other preparations. The Tissue Processing System will enable users, e.g., researchers, clinicians, forensic scientists, and many disciplines to perform identical processing on biosamples, reducing user variability, and throughput constraints of manual processing.

Embodiments of the Tissue Processing System can prepare single nuclei suspensions or single cells or nucleic acids for analysis by methods comprised of bulk and single nuclei DNA sequencing, DNA microarrays, RNA sequencing, mass spectrometry, Raman spectroscopy, electrophysiology, flow cytometry, mass cytometry, and many other analytical methods well known to one skilled in the art including multidimensional analysis (e.g., LC/MS, CE/MS, etc.) and multi-'omics (e.g., genomic and proteomic analysis, genomic and cell surface analysis, etc.).

The Tissue Processing System embodiment described is compatible with commercially available downstream library preparation and analysis by NGS sequencers. The term NGS is used to connote either NGS or nanopore or, single molecule sequencing or other sequencing methods or sample preparation methods as appropriate without limitation. As contemplated herein, next generation sequencing refers to high-throughput sequencing, such as massively parallel sequencing (e.g., simultaneously (or in rapid succession) sequencing any of at least 1,000, 100,000, 1 million, 10 million, 100 million, or 1 billion polynucleotide molecules). Sequencing methods may include, but are not limited to: high-throughput sequencing, pyrosequencing, sequencing-by-synthesis, single-molecule sequencing, nanopore sequencing, semiconductor sequencing, sequencing-by-ligation, sequencing-by-hybridization, RNA-Seq (Illumina), Digital Gene Expression (Helicos), next generation sequencing, Single Molecule Sequencing by Synthesis (SMSS) (Helicos), massively-parallel sequencing, Clonal Single Molecule Array (Solexa), shotgun sequencing, Maxam-Gilbert or Sanger sequencing, primer walking, sequencing using PacBio, SOLiD, Ion Torrent, Genius (GenapSys) or nanopore (e.g., Oxford Nanopore, Roche) platforms and any other sequencing methods known in the art.

In another aspect provided herein is an apparatus, composition of matter, or article of manufacture, and any improvements, enhancements, and modifications thereto, as described in part or in full herein and as shown in any applicable Figures, including one or more features in one or more embodiment.

In another aspect provided herein is an apparatus, composition of matter, or article of manufacture, and any improvements, enhancements, and modifications thereto, as described in part of in full herein and as shown in any applicable Figures, including each and every feature.

In another aspect provided herein is a method or process of operation or production, and any improvements, enhancements, and modifications thereto, as described in part or in full herein and as shown in any applicable Figures, including one or more feature in one or more embodiment.

In another aspect provided herein is a method or process of operation or production, and any improvements, enhancements, and modifications thereto, as described in part or in full herein and as shown in any applicable Figures, including each and every feature.

In another aspect provided herein is a product, composition of matter, or article of manufacture, and any improvements, enhancements, and modifications thereto, produced or resulting from any processes described in full or in part herein and as shown in any applicable Figures.

In one embodiment the single-cell or nuclei suspension is prepared for a bioanalysis module for downstream analysis including but not limited to sequencing, next generation sequencing, proteomic, genomic, gene expression, gene mapping, carbohydrate characterization and profiling, lipid characterization and profiling, flow cytometry, imaging, DNA or RNA microarray analysis, metabolic profiling, functional, or mass spectrometry, or combinations thereof.

In another aspect provided herein is a data analysis system that correlates, analyzes, and visualizes the analytical information of a sample component such as its degree of single cell or nuclei dissociation, with the processing step and measures the change over time, and/or amount of enzymatic activity, and/or physical and/or chemical or enzymatic disruptions of the original biological specimen.

In another aspect provided herein is a data analysis system that correlates, analyzes, and visualizes the analytical information of a sample component such as its degree of single cell or nuclei dissociation, with the processing step and measures the change over time, and/or amount of enzymatic/chemical activity, and/or physical disruptions of the original biological specimen and adjusts the processing parameters from the analytical information.

The Tissue Processing System is a novel platform that automates and standardizes the processing FFPE tissues into single nuclei suspensions. This will have broad impacts. Process standardization will be critical for comparison of data from lab to lab or research to researcher. The Human Cell Atlas project intends to freely share the multi-national results in an open database. However, with no standardization of the complete process, direct comparisons will greatly suffer from widely varying impacts of the first processing step of producing single-cells or nuclei from tissue. Additionally, when single-cell or nuclei sequencing becomes clinically relevant, the standardization and de-skilling of the production of single-cells or nuclei from FFPE tissues will be required to be performed by an automated instrument such as the Tissue Processing System.

In another aspect, provided herein is a system comprising: (a) an instrument comprising: (i) one or more cartridge interfaces configured to engage a cartridge; (ii) a fluidics module comprising: (1) one or more containers containing one or more liquids and/or gasses and/or solids that may be dissolved to form liquids; (2) one or more fluid lines connecting the containers with fluid ports in the cartridge interface; and (3) one or more pumps configured to move liquids and/or gasses into and/or out of the fluid port(s); (iii) a mechanical module comprising an actuator; (iv) optionally, a magnetic processing module comprising a source of magnetic force, wherein the magnetic force is positioned to form a magnetic field in the processing chamber; (v) optionally, a measurement module; (vi) optionally, a control module comprising a processor and memory, wherein the memory comprises code that, when executed by the processor, operates the system; and (b) one or more cartridges, each engaged with one of the cartridge interfaces, wherein each cartridge comprises: (i) a sample inlet port; (ii) one or more cartridge ports communicating with the fluid ports in the cartridge interface; (iii) a processing chamber communicating with the sample inlet port and with at least one cartridge port, and comprising a tissue disruptor configured for mechanical disruption of tissue, wherein the tissue disruptor engages with and is actuated by the actuator when the cartridge is engaged with the cartridge interface; (iv) an optional strain chamber communicating with the processing chamber configured to separate cells and/or nuclei from disrupted tissue; (v) an optional post-processing chamber communicating with the strain chamber, optionally communicating with one or more cartridge ports and configured to perform one or more processing steps on separated cells and/or nuclei when required; and (vi) optionally, one or more waste chambers fluidically connected with the processing chamber. In one embodiment the tissue disruptor comprises a grinder, a pestle or a variable orifice. In another embodiment the system further comprises a barcode reader. In another embodiment the system comprises a measurement module (vii) that performs optical imaging to measure titer, clumping, and/or viability of cells or nuclei or properties of biomolecules. In another embodiment the system comprises a measurement module (viii) and a control system (ix), wherein the measurement module measures, and one or more time points, characteristics of a sample in the processing chamber, and control system comprises code that determines a state of the sample, e.g., viability or degree of single cell or nuclei dissociation or degree of deparaffinization or rehydration, etc., and optionally adjusts processing parameters. In another embodiment the system further comprises (c) a device to hold one or more FFPE tissues during the cartridge processing. In another embodiment the system further comprises (d) an analysis module, wherein an input port of the analysis module is in fluid communication with the processing chamber. In another embodiment the analysis module performs an analysis selected from one or more of: DNA sequencing, next generation DNA sequencing, proteomic analysis, genomic analysis, gene expression analysis, gene mapping, carbohydrate characterization and profiling, lipid characterization and profiling, flow cytometry, imaging, DNA or RNA microarray analysis, metabolic profiling, functional analysis, and mass spectrometry. In another embodiment the cartridge interface comprises a means of positioning the cartridge in the instrument that engages the fluidic module and the mechanical module and optionally is temperature controlled. In another embodiment the cartridge is disposable.

In another aspect provided herein is a method comprising: (a) providing a FFPE tissue sample to a processing chamber: (b) automatically performing deparaffinization, rehydration, mechanical and enzymatic/chemical disruption of the tissue in the processing chamber to produce disrupted tissue comprising released nuclei and/or cells and debris; (c) automatically moving the disrupted tissue into an optional strain chamber comprising a strainer and/or filter and separating the released nuclei and/or cells from the debris therein; and (d) automatically moving the released cells and/or nuclei into a post-processing chamber. In another embodiment (e) further comprises performing at least one processing step on the released cells and/or nuclei in the processing chamber. In another embodiment processing comprises one or more automatically performed processes selected from: (I) deparaffinizing FFPE tissue; (II) rehydrating deparaffinized FFPE tissue; (III) isolating cell or nuclei suspensions; (IV) isolating protein; (V) converting RNA into cDNA; (VI) preparing one or more libraries of adapter tagged nucleic acids; (VII) performing PCR; (VIII) isolating individual cells or individual nuclei in nanodrops or nanoboluses: and (IX) outputting released cells and/or nuclei into output vessels such as 8 well strip tubes, microtiter plates, Eppendorf tubes, a chamber in the cartridge, or other vessels capable of receiving the cell suspensions, libraries, or other output. In another embodiment the method further comprises: (e) automatically capturing the released cells and/or nuclei in the post-processing chamber by binding to magnetically attractable particles comprising moieties having affinity for the cells and/or nuclei and applying a magnetic force to the processing chamber to immobilize the captured cells and/or nuclei. In another embodiment the method further comprises: (f) automatically monitoring cell and/or nuclei titer in the processing chamber and, when the titer reaches a desired level, exchanging a dissociation solution used to dissociate the tissue for a buffer.

In another aspect provided herein is a cartridge comprising: (i) a sample inlet port; (ii) one or more cartridge ports configured to communicate with fluid ports in a cartridge interface; (iii) a processing chamber communicating with the sample inlet port and with at least one cartridge port, and comprising a tissue disruptor configured for mechanical disruption of tissue, wherein the tissue disruptor engages with and is actuated by the actuator when the cartridge is engaged with the cartridge interface; (iv) a post-processing chamber containing one or more strainers, optionally communicating with one or more cartridge ports and configured to perform one or more processing steps on separated cells: and (v) optionally, one or more waste chambers fluidically connected with the post-processing chamber. In another embodiment the cartridge further comprises a cap that opens and closes the sample inlet port. In another embodiment the cap comprises a tissue disruptor element that moves about rotationally and back and forth along an axis. In another embodiment the cartridge further comprises a holder that retains the FFPE tissue when required during processing. In another embodiment the cartridge further comprises a top piece and a bottom piece connected by collapsible element which allow the top piece and/or the bottom piece to move relative to the holder. In another embodiment the holder comprises one or more a mesh screens or filters. In another embodiment the holder comprises two surfaces each with a mesh screen or filter. In another embodiment the holder comprises two surfaces each with a mesh screen or filter or porous material that are joined by magnetic forces, or connected through a hinge or connected by snap-together features. In another embodiment the cartridge further comprises a grinding element for grinding tissue in the processing chamber. In another embodiment the cartridge further comprises a barcode comprising information about the cartridge and/or its use. In another embodiment the cartridge further comprises a plunger configured to move slideably within the processing chamber.

### BRIEF DESCRIPTION OF THE DRAWINGS

The skilled artisan will understand that the drawings, described below, are for illustration purposes only. The drawings are not intended to limit the scope of the present teachings in any way.

FIG. 1 shows a Sample Processing System that processes specimens into biocomponents such as single cells or nuclei for bioanalysis.

FIG. 2 shows a Tissue Processing System that processes FFPE tissue specimens into biocomponents such as single cells or nuclei or other for bioanalysis.

FIG. 3 shows a Tissue Processing System that processes FFPE tissue specimens into biocomponents such as single cells or nuclei or other components for bioanalysis.

FIG. 4 shows an overview of a Tissue Processing System and some exemplary modules. Tissue specimens or other specimens are processed into single cells, nuclei, nucleic acids, single-cell libraries, and other biologicals through the use of one or more cartridges and one or more of the Physical Dissociation Subsystem, the Enzymatic and Chemical Dissociation Subsystem, the Measurement Subsystem, the Fluidic Subsystem, the Control Subsystem, and a Magnetic Module.

FIG. 5 shows an exemplary overall process to extract nuclei from FFPE preserved tissues.

FIG. 6 shows the overall design concept for a prototype showing functional system and a few example modalities of mechanical disruption and examples of chemicals and enzymes to dissociate FFPE tissue specimens into single cells, nuclei, and other biomolecules.

FIG. 7 shows an example of a Single-Sample Tissue Processing System with mechanical disruption in a single cartridge with a bank of enzymes and reagents located in the instrument to dissociate solid tissue specimens into single cells, nuclei, and other biomolecules.

FIG. 8 shows another example of a Single-Sample Tissue Processing System with mechanical disruption in a single cartridge with a bank of enzymes and reagents located separately from the instrument in a reagent module.

FIG. 9 shows the front of an example of a Single-Sample Tissue Processing System to dissociate FFPE tissue specimens into single nuclei suspensions, and other biomolecules using a cartridge.

FIG. 10 shows the back of an example of the Single-Sample Tissue Processing System.

FIG. 11 A-C shows an example of a cartridge with processing, post-processing, and vacuum trap chambers for processing FFPE tissue specimens into single nuclei, single cells, and other biomolecules.

FIG. 12 shows a tissue ring to retain an FFPE specimen during processing

FIG. 13 A-D show an example of adding reagents to a cartridge with a tissue ring, mixing the reagents, removing the reagents, and mechanically disrupting the tissue in the tissue ring for processing solid tissue specimens into single cells, nuclei, and other biomolecules and details of the assembly of the cap.

FIG. 14 A-D show an example of a cartridge with a tissue basket, loading the tissue, closing the basket, and moving the basket to circulate reagents, remove the reagents, and mechanically disrupting and processing FFPE tissue specimens into single nuclei, and other biomolecules.

FIG. 15 shows an exemplary computer system.

FIG. 16 shows a cartridge architecture using pinch valves to direct liquid flows.

FIG. 17 shows an exemplary cartridge fluidic architecture.

### DETAILED DESCRIPTION OF THE INVENTION

NGS, mass spectrometry, fluorescent activated cell sorting (FACS), and other modern high-throughput analysis systems have revolutionized life and medical sciences. The progression of information has been from the gross level of organism, to tissue, and now to single cell analysis, Single cell analysis of genomic, proteomic including protein expression, carbohydrate, lipid, and metabolism of individual cells is providing fundamental scientific knowledge and revolutionizing research and clinical capabilities.

All patents, patent applications, published applications, treatises and other publications referred to herein, both supra and infra, are incorporated by reference in their entirety. If a definition and/or description is set forth herein that is contrary to or otherwise inconsistent with any definition set forth in the patents, patent applications, published applications, and other publications that are herein incorporated by reference, the definition and/or description set forth herein prevails over the definition that is incorporated by reference.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Both plural and singular means may be included.

Specimen: The term “specimen,” as used herein, refers to an in vitro cell, cell culture, virus, bacterial cell, fungal cell, plant cell, bodily sample, FFPE sample, or tissue sample that contains genetic material. In certain embodiments, the genetic material of the specimen comprises RNA. In other embodiments, the genetic material of the specimen is DNA, or both RNA and DNA. In certain embodiments the genetic material is modified. In certain embodiments, a tissue specimen includes a cell isolated from a subject. A subject includes any organism from which a specimen can be isolated. Non-limiting examples of organisms include prokaryotes, eukaryotes, or archaebacteria, including bacteria, fungi, animals, plants, or protists. The animal, for example, can be a mammal or a non-mammal. The mammal can be, for example, a rabbit, dog, pig, cow, horse, human, or a rodent such as a mouse or rat. In particular aspects, the tissue specimen is a human tissue sample. The tissue specimen can be liquid, for example, a blood sample, red blood cells, white blood cells, platelets, plasma, serum. The specimen, in other non-limiting embodiments, can be saliva, a cheek, throat, or nasal swab, a fine needle aspirate, a tissue print, cerebral spinal fluid, mucus, lymph, feces, urine, skin, spinal fluid, peritoneal fluid, lymphatic fluid, aqueous or vitreous humor, synovial fluid, tears, semen, seminal fluid, vaginal fluids, pulmonary effusion, serosal fluid, organs, bronchio-alveolar lavage, tumors, frozen cells, or constituents or components of in vitro cell cultures. In other aspects, the tissue specimen is a solid tissue sample or a frozen tissue sample or a biopsy sample such as a fine needle aspirate or a core biopsy or a resection or other clinical or veterinary specimen. In other aspects, the tissue specimen is a FFPE preserved sample such as a biopsy sample such as a fine needle aspirate or a core biopsy or a resection or other clinical or veterinary specimen. In still further aspects, the specimen comprises a virus, bacteria, or fungus. The specimen can be an ex vivo tissue or sample or a specimen obtained by laser capture microdissection. The specimen can be a fixed specimen, including as set forth by U.S. Published Patent Application No. 2003/0170617 filed Jan. 28, 2003.

In some embodiments, the single cells can be analyzed further for biomolecules including one or more polynucleotides or polypeptides or other macromolecules. In some embodiments, the polynucleotides can include a single-stranded or double-stranded polynucleotide. In some embodiments, the polypeptide can include an enzyme, antigen, hormone or antibody. In some embodiments, the one or more biomolecules can include RNA, mRNA, cDNA, DNA, genomic DNA, microRNA, long noncoding RNA, ribosomal RNA, transfer RNA, chloroplast DNA, mitochondrial DNA, or other nucleic acids including modified nucleic acids and complexes of nucleic acids with proteins or other macromolecules.

It will be readily apparent to one of ordinary skill in the art that the embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

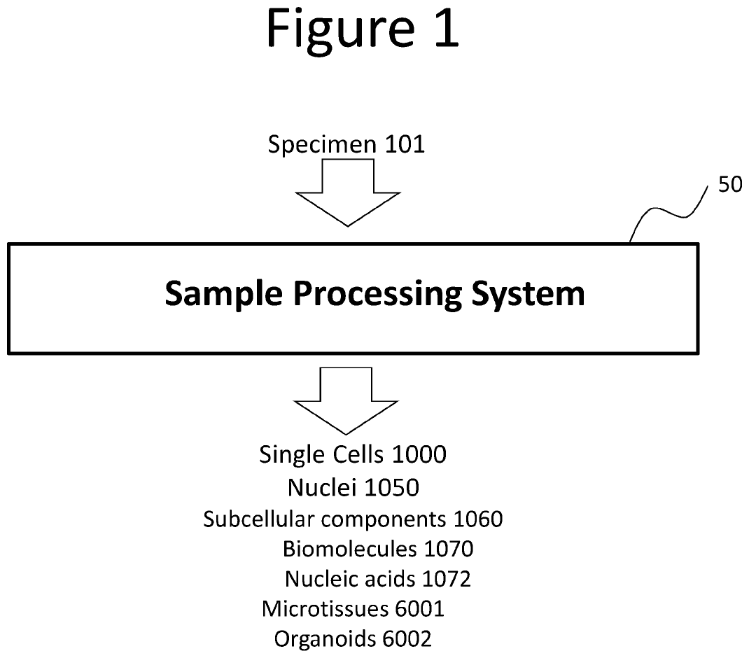

FIG. 1 shows a Sample Processing System 50 that can input specimen 101 and process them to produce biologicals such as single cells 1000 or nuclei 1050, microtissues 6001, organoids 6002, or other biocomponents comprised of subcellular components 1060, and biomolecules 1070 such as macromolecules 1071 and nucleic acids 1072, comprised of DNA 1073 and RNA 1074; proteins 1075; carbohydrates 1076; lipids 1077: biomolecules 1070 with multiple types of macromolecules 1071, metabolites 1078; and other biological components, including natural products 1079 for bioanalysis.

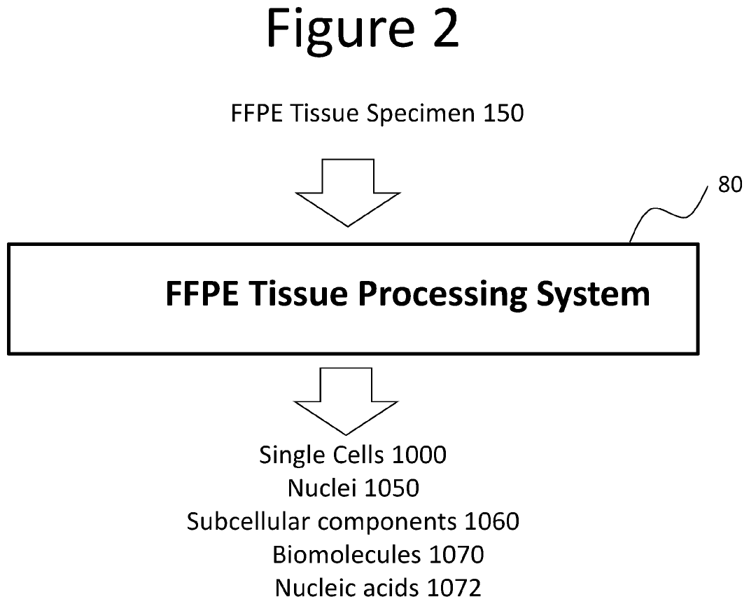

FIG. 2 shows an FFPE Tissue Processing System 80 that can input FFPE tissue specimen 150 and other specimens 101 and process them to produce biologicals such as single nuclei 1050 or single cells 1000, or other biocomponents comprised of subcellular components 1060, and biomolecules 1070 such as macromolecules 1071 and nucleic acids 1072, comprised of DNA 1073 and RNA 1074; proteins 1075: carbohydrates 1076: lipids 1077; biomolecules 1070 with multiple types of macromolecules 1071; metabolites 1078; and other biological components, including natural products 1079 for bioanalysis.

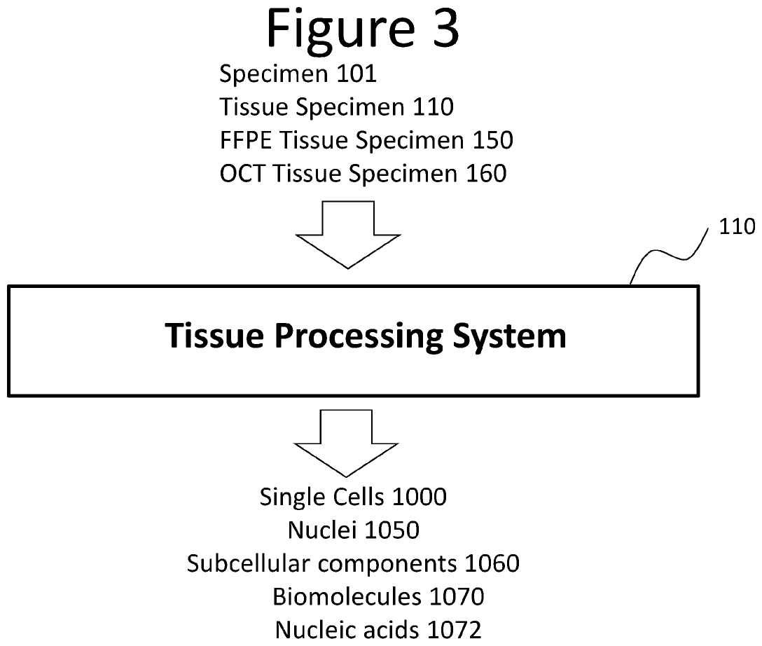

FIG. 3 shows a Tissue Processing System 110 that accepts one or more specimens 101 or tissue specimens 110 or FFPE tissue specimens 150 or OCT tissue specimens 160, other specimens including blood or PBMCs and processes them to produce biologicals such as single cells 1000 or nuclei 1050, or other biocomponents comprised of subcellular components 1060, and biomolecules 1070 such as macromolecules 1071 and nucleic acids 1072, comprised of DNA 1073 and RNA 1074 and single cell libraries 1200 for bioanalysis.

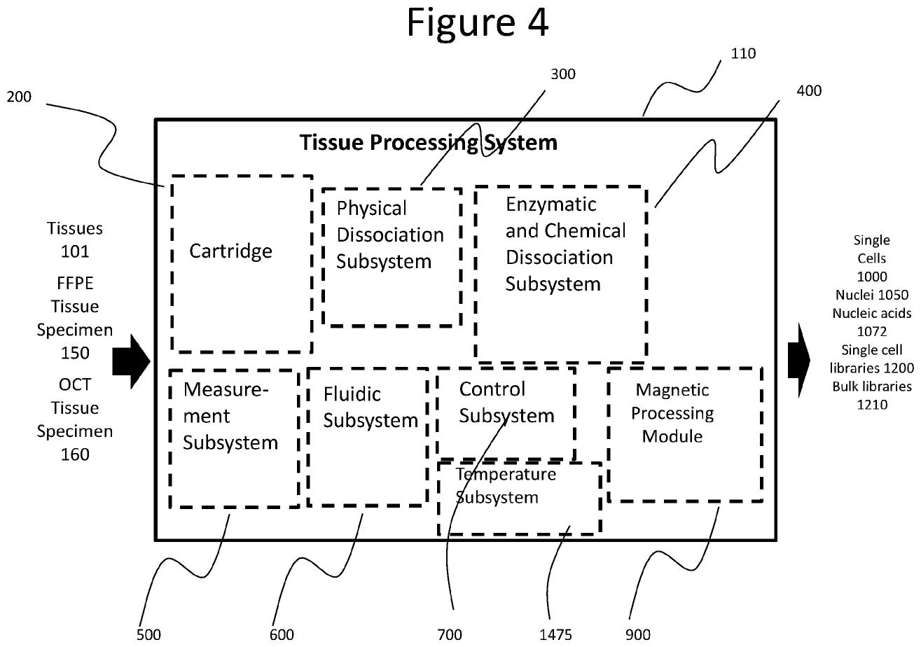

Referring to FIG. 4, in many embodiments, the Tissue Processing System 110 processing is performed in cartridges 200 in the system. FFPE tissue specimens 150 or OCT tissue specimens 160 or other specimens 101 are converted to single nuclei 1050, single cells 1000, or other organelles, or biomolecules or single cell libraries 1200 or bulk libraries 1210 through the use of cartridge 200 with one or more of the Physical Dissociation Subsystem 300, the Enzymatic and Chemical Dissociation Subsystem 400, the Measurement Subsystem 500, the Fluidic Subsystem 600, the Control Subsystem 700, the Magnetic Module 900, and the Temperature Subsystem 1475.

The Physical Dissociation Subsystem 300 can perform mixing or perform physical disruption by passing the specimen through orifices, grinding, rotating a rotor with features to dissociate tissue, forcing tissue through screens or mesh, sonication, ultrasonics, blending, homogenization, bead beating, and other methods known to one skilled in the art to physically disrupt tissue to help produce single cells.

The Enzymatic and Chemical Dissociation Subsystem 400 can perform deparaffinization by adding xylene or xylene substitutes to the cartridge and perform rehydration by adding mixtures of ethanol with increasing amounts of water or buffer. The Enzymatic and Chemical Dissociation Subsystem 400 can perform crosslink reversal and/or enzymatic disruption by adding formulations of a reagents or mixture of components comprised of but not limited to proteinase K, collagenases (e.g., collagenases type I, II, III, IV, and others), elastase, trypsin, papain, hyaluronidase, chymotrypsin, neutral protease, clostripain, caseinase, neutral protease (Dispase®), DNAse, protease XIV, RNase inhibitors, or other enzymes, biochemicals, or chemicals such as EDTA, protease inhibitors, buffers, acids, or base.

Another aspect or the Enzymatic and Chemical Dissociation Subsystem 400 can perform chemical disruption or chemical and enzymatic disruption is by adding formulations of chemicals that can disrupt tissue or cellular integrity such as Triton X-100, Tween, Nonident P40, octyl glucoside, polyoxyethylene(9)dodecyl ether, digitonin, IGEPAL™ CA630 octylphenyl polyethylene glycol, n-octyl-beta-Dglucopyranoside (betaOG), n-dodecyl-beta, Tween™ 20 polyethylene glycol sorbitan monolaurate, Tween™ 80 polyethylene glycol sorbitan monooleate, polidocanol, n-dodecyl beta-D-maltoside (DDM), NEMO nonylphenyl polyethylene glycol, C12E8 (octaethylene glycol ndodecyl monoether), hexaethyleneglycol mono-n-tetradecyl ether (C14E06), octyl-betathioglucopyranoside (octyl thioglucoside, OTG), Emulgen, and polyoxyethylene 10 lauryl etherother surfactants, or detergents or chemicals that can dissociate tissue into cells or produce nuclei or other organelles.

In other embodiments, different reagents or mixtures of reagents are applied sequentially to dissociate the FFPE or OCT sample or specimen into single cells 1000 or nuclei 1050. The physical and enzymatic/chemical dissociation systems can be separate from each other, or they can be co-located (e.g., acting upon the sample simultaneously or sequentially).

In some embodiments, the amount of dissociation is monitored at intervals during the dissociation or at the endpoint, and in some instances the viability is determined during processing using a Measurement Subsystem 500. The Measurement Subsystem 500 can be an optical imaging device to image cells or nuclei or tissue using brightfield, phase contrast, fluorescence, chemiluminescence, near-field, or other optical readouts, or an electrical measurement, such as an impedance measurement of the change in conductivity when a cell passes through a sensor, or other types of measurement.

The addition and movement of fluids can be performed by a Fluidic Subsystem 600. The Fluidic Subsystem 600 can use syringe pumps, piezopumps, on-cartridge pumps and valves, vacuum (negative pressure), pressure, pneumatics, or other components well known to one skilled in the art.

The Tissue Processing System 110 can be controlled by software in a Control Subsystem 700 which can be comprised of a user interface 740 through a monitor, embedded display, or a touch screen 730 to communicate with and control devices, modules, subsystems, instruments, and systems. In some instances the Control Subsystem 700 can include interfaces to smart devices, laboratory information management systems, other instruments, analysis software, display software, databases, email, and other applications. The Control Subsystem 700 can include control software 725 and scripts that control the operation and in some embodiments the scripts can be revised, created, or edited by the operator.

In another aspect provided herein is a device for the dissociation of a biological sample, the device comprising: (i) a biological sample or specimen 101; (ii) a cartridge 200 capable of dissociating tissue; (iii) an instrument to operate the cartridge 200 and provide fluids as needed (iv) a measurement module 500 such as an optical imaging to measure titer, clumping, and/or viability, (v) exchange of dissociation solution for buffer or growth media at the desired titer, and (vi) output vessels such as a chamber in the cartridge, 8 well strip tubes, microtiter plates, Eppendorf tubes or other vessels capable of receiving cell suspensions.

In another aspect provided herein is a device for the dissociation of a biological sample and the production of single-cell 1000 or nuclei 1050 suspensions or matched bulk nucleic acids 1010 or single cell libraries 1200 or matched bulk libraries 1210, the device comprising: (i) a chamber or area to input a biological sample or specimen either directly or in a device; (ii) a cartridge capable of dissociating tissue or specimen; (iii) an instrument to operate the cartridge and provide fluids as needed (iv) a measurement module such as an optical imaging to measure titer, clumping, and/or viability, necrosis, cytotoxicity, apoptosis, etc. (v) exchange of dissociation solution for buffer or growth media at the desired titer, (vi) the production of single-cell 1000 or nuclei 1050 suspensions or single cell libraries 1200, and matched bulk nucleic acid libraries 1210, in output vessels such as 8 well strip tubes, microtiter plates, Eppendorf tubes, a chamber in the cartridge, or other vessels capable of receiving cell suspensions.

Referring to FIG. 4, a Magnetic Processing module 900 can use magnetic processing of magnetic and paramagnetic particles or beads or surfaces or other sizes and shapes, referred to as beads, to separate single cells 1000, or cell types, or nuclei 1050, or other biocomponents comprised of subcellular components 1060, and biomolecules 1070 such as macromolecules 1071 and nucleic acids 1072, comprised of DNA 1073 and RNA 1074; proteins 1075; carbohydrates 1076; lipids 1077; biomolecules 1070 with multiple types of macromolecules 1071: metabolites 1078; and other biological components, including natural products 1079 for bioanalysis. In some embodiments the beads have a surface chemistry that facilitates the purification of the biologicals in conjunction with the chemical conditions. In other embodiments the beads have affinity molecules comprised of antibodies, aptamers, biomolecules, etc. that specifically purify certain biologicals such as cell types, nucleic acids, nuclei 1050, or other components of tissue or samples.

In another aspect provided herein is a device for the dissociation and single-cell library preparation of a biological sample, the device comprising: (i) a chamber or area to input a biological sample or specimen: (ii) a cartridge 200 capable of dissociating FFPE tissue specimens 150 or OCT tissue specimen 160 or other tissue specimen 110 into single-nuclei 1050 and then produce single-nuclei libraries 1200; (iii) an instrument to operate the cartridge 200 and provide fluids as needed (iv) a measurement subsystem 500 such as an optical imaging to measure titer, clumping, and/or viability, (v) exchange of dissociation solution for buffer at the desired titer, (vi) a magnetic processing or other processing chamber or tubing to perform magnetic separations, normalizations, purifications, and other magnetic processes, for example, to purify nucleic acids, couple enzymatic reactions such as library preparation reactions, and other processes including producing single-cells or nuclei in isolation, such as nanodrops, nanoboluses, or physical separation, (vii) output vessels such as 8 well strip tubes, microtiter plates, Eppendorf tubes, a chamber in the cartridge, or other vessels capable of receiving cell suspensions.

The basic elements of the Tissue Processing System 110 can be configured in multiple ways depending on the specimen(s) 101 or FFPE tissue specimens 150 or or OCT tissue specimens 160 and analytes to be analyzed. In the following example, one of the numerous configurations are described in detail but in no way is the invention limited to these configurations as will be obvious to one skilled in the art. The Tissue Processing System 110 can accommodate many different types of specimens 101, comprised of fresh tissue; snap-frozen tissue, microtome slices (cryo, laser or vibrating) of tissue; fixed tissue; bulk material obtained by surgical excision, biopsies, fine needle aspirates; samples from surfaces, and other matrices, or FFPE tissue specimens 150.

The instant disclosure teaches how to produce a system that processes FFPE tissue specimens 150 and OCT tissue specimens 160 and other samples into preferentially nuclei 1050 or into single-cells 1000. The process may require adapting to the widely varying starting types of FFPE tissue specimens 150, with different requirements depending on the tissue, species, age, and state.

In the instant invention, many embodiments are possible and are incorporated by reference from patent application PCT/US2017/063811 filed Nov. 29, 2017 (Jovanovich, Chear, McIntosh, Pereira, and Zaugg, “Method and Apparatus for Processing Tissue Samples”) and from patent application PCT/US19/35097 filed Jun. 1, 2019 (Jovanovich, Chear, Leisz, Eberhart, and Bashkin, “Method and Apparatus for Processing Tissue Samples”); the contents of all are incorporated herein in their entirety as well as the number system used therein except where there is conflict the numbering herein predominates.

This disclosure describes how to automate, integrate, and importantly standardize the complete process to create single-nuclei 1050 in a single sample Tissue Processing 110 system embodiment using a novel mechanism to retain the tissue and a novel cartridge design. It is obvious to one skilled in the art that multi-sample embodiments can be accomplished with the same instant invention. The Tissue Processing System 110 will greatly enable basic researchers, students, and translational researchers as well as clinicians and others with its ease of use and high performance.

### Single-Use Cartridge Designs.

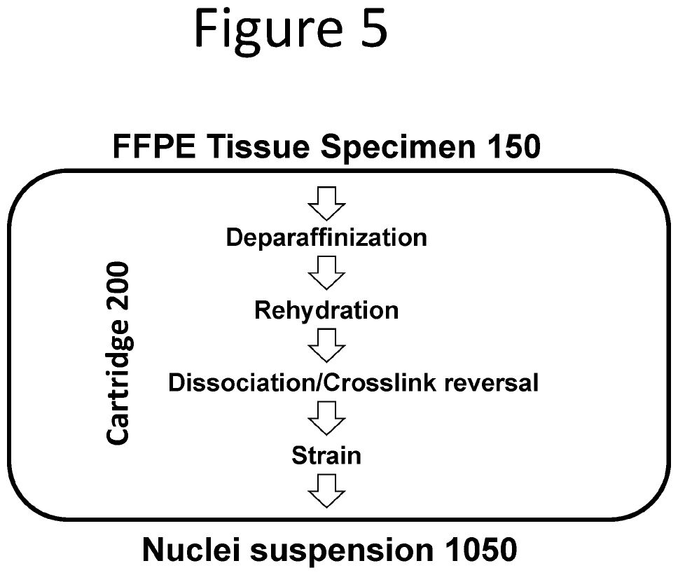

Cartridges 200 can be used to process tissue into single-cell 1000 suspensions or nuclei 1050 and are preferrably single-use. Referring to FIG. 5, the major workflow steps to process FFPE tissue specimens 150 in a cartridge 200 are to deparaffinize, rehydrate and then dissociate the tissue with optional crosslink reversal before filtering the single-nuclei suspension 1050. The major workflow steps to process OCT tissue specimens 160 are to rinse OCT residue off the sample with a reagent, removal of the rinse solution, addition of a dissociation reagent, and optionally followed by mechanical tissue dissociation.

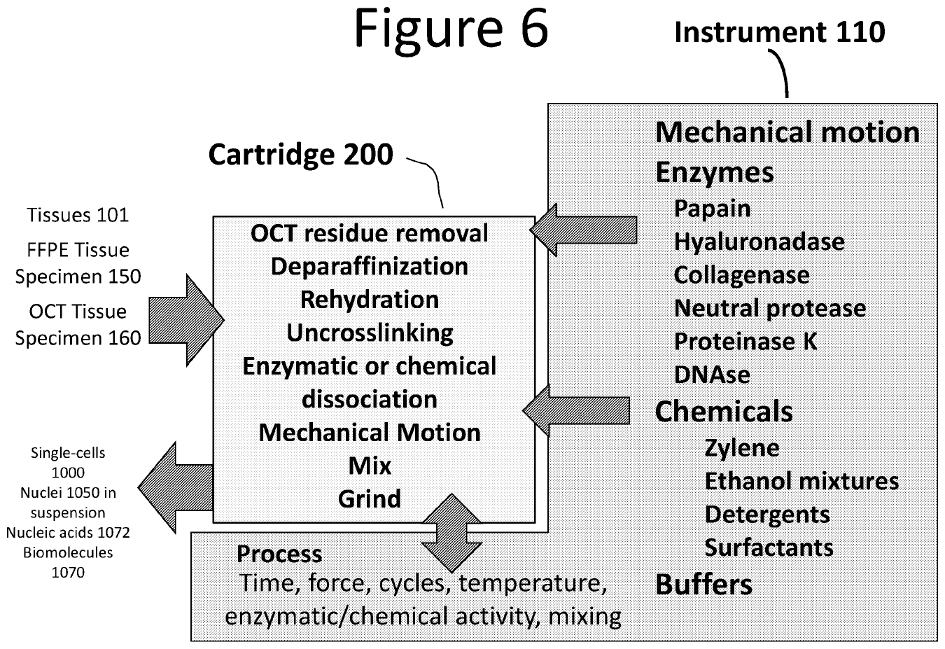

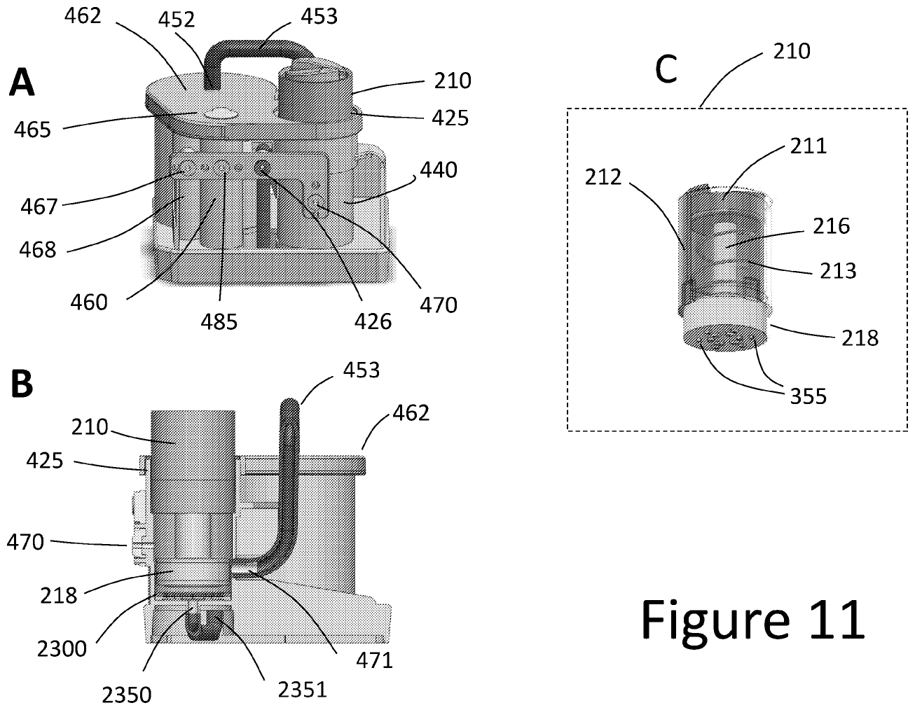

Referring to FIG. 6, cartridge 200 will input specimen 101 or FFPE tissue specimen 150 or OCT tissue specimen 160 and output singulated cells 1000 or nuclei 1050. The Tissue Processing System 110 as shown conceptually in FIG. 6 combines the mechanical disruption of specimen 101 on cartridge 200, adds reagents such as chemicals, detergents, enzymatic or chemical dissolution solutions 410 and other fluids according to the protocols, and controls sample movement, pressures, and temperature. The Tissue Processing System 110 can move or rotate mechanical tissue disruptor elements comprised of without limitation a syringe plunger, pestle, Dounce pestle, or grinder, using a z axis stepper 2110 with a rotary motor 2120 coupled through the cap 210. Referring to FIG. 11C, the term plunger is at times used to refer to combination of shaft/piston 216 and rotor 218 with optional disruption features 355 with spring 213 in sheath 212.

In a preferred embodiment, the mechanical tissue disruptor elements have features 355 on the bottom of the rotor or grinder that can mechanically disrupt tissue at the bottom or floor of Processing Chamber 440 which in some embodiments may have complementary features 355 to aid in the disruption of the tissue. Disruption also occurs in the ‘side gap’ between the rotor and the side wall of Processing Chamber 440 in some embodiments.

It is desirable that disposable cartridge 200 process multiple types of preserved FFPE 150 or OCT 160 tissues with mechanical disruption and enzymatic or chemical dissociation that can be adjusted according to the tissue type and condition of the FFPE tissue, such as age, or chemical process. The cartridge 200 can be designed to process tissue as quickly and as gently as possible, not expose the operator to the tissue being processed, and be manufacturable at low cost. Multiple mechanical methods may be needed to accommodate the wide range of tissues and their individual requirements: designs are shown that can be readily adapted to multiple different mechanical disruption methods comprising variable orifice 490, grinding with rotating plungers 336, pestles 361, and straining and filtering using a plunger 362 as well as other mechanical methods without limitation.

Cartridges 200 can be designed for 3D printing, injection molding in plastics with single or double pulls and low labor assembly, or layered assembly of fluidic and other layers, combinations of methods, and other methods well known to one skilled in the art. Fluids can be delivered to cartridge 200 by pumps such as a syringe pump 2130 or by vacuum or can be preloaded onto cartridge 200 or many combinations. In some embodiments, flexible tubing 493 can connect chambers and creates simple pinch valves 491 to direct flow. In other embodiments, channels are created in the cartridge 200 and valves can be incorporated such as pneumatic valves, or other valves.

### Tissue Processing System Embodiment

In one embodiment of the Sample Processing System 50 as a Tissue Processing System 80, as shown in FIG. 2, the Tissue Processing System 110 can perform powerful integrated tissue-to-genomics or sample-to-other answer (genomic, proteomic, metabolomic, or epigenetic, multi-omics, etc.) analysis functionality for scientists to simply and standardize the production and or analysis of single-cell 1000 or nuclei 1050 suspensions, affinity purified single cells 1100, affinity purified nuclei 1105, nucleic acids 1072, and bulk libraries 1210 from solid or liquid tissues. As will be obvious to one skilled in the art, the biological materials produced such as single cells 1000, nuclei 1050, nucleic acids 1072, single cell libraries 1200, single nuclei libraries 1250, bulk libraries 1210, or other biocomponents comprised of subcellular components 1060, or biomolecules 1070 such as macromolecules 1071 and nucleic acids 1072, comprised of DNA 1073 and RNA 1074, can also be used for many genomic, cell biology, proteomics, metabolomics, and other analytical methods.

The Tissue Processing System 110 can integrate the preparation of biological materials from FFPE tissue specimens 150 or OCT tissue specimen 160 with measurement subsystems 500 that perform an analysis selected from one or more of: DNA or RNA sequencing, next generation DNA or RNA sequencing, next next generation DNA or RNA sequencing of nucleic acids and their adducts such as epigenetic modifications; nanopore sequencing of nucleic acids and their adducts; single cell DNA sequencing of nucleic acids and their adducts; single nuclei RNA sequencing of nucleic acids and their adducts; PCR, digital droplet PCR, qPCR, RT-qPCR; genomic analysis, gene expression analysis, gene mapping, DNA fragment mapping; imaging including optical and mass spectrometry imaging: DNA or RNA microarray analysis: fluorescent, Raman, optical, mass spectrometry and other detection modalities of nucleic acids acids and their adducts with and without labels; proteomic analysis including fluorescent. Raman, optical, mass spectrometry, protein sequencing, and other detection modalities of proteins and peptides and their adducts and modifications with and without labels: carbohydrate characterization and profiling including sequencing, fluorescent, Raman, optical, mass spectrometry, and other detection modalities of carbohydrates and their adducts and other covalent polymers with and without labels; lipid characterization and profiling including sequencing, fluorescent, Raman, optical, mass spectrometry, and other detection modalities of lipids and their adducts and other covalent polymers with and without labels; flow cytometry; characterization of cells and profiling including fluorescent, Raman, optical, mass cytometer, and other detection modalities of cells and their adducts and other covalent polymers with and without labels; metabolic profiling including sequencing, fluorescent. Raman, optical, mass spectrometry, and other detection modalities of metabolites and their adducts and other covalent polymers with and without labels; functional analysis including protein-protein interactions, protein-lipid interactions, protein-DNA interactions, RNA-DNA interactions, and other interactions between molecules derived from biological materials, with and without labels: bioinformatic analysis of cells, organelles, and biomolecules; and mass spectrometry and other analytical methods. In some embodiments the measurement system 500 can be physically integrated and fluids transferred by robotic pipetting, fluid flow through tubing or capillaries, centrifugal methods, or other methods.

Referring to FIG. 6, in this preferred embodiment mechanical and enzymatic dissociation is performed in single-use cartridges 200 in one or more processing chambers 440 to produce nuclei suspensions 1200, single-cell suspension 1000 or, nucleic acids 1072, biomolecules 1070, subcellular components 1060, or other products. The samples can then be processed in the one or more post-processing chamber(s) 460 by optional bead-based affinity purification of cell types by surface antigens to produce affinity purified single-cell suspensions 1100 or nuclear suspensions by nuclear antigens 1105 or nucleic acids 1072, biomolecules 1070, subcellular components 1060 can be further processed into purified mRNA, NGS libraries, or other sample types. In some embodiments, one or more of the processing 440 and post-processing chambers 460 and strain chambers 450 and vacuum trap chambers 468 and waste chambers 430 or other chambers can be combined.

### Computer Systems

Models provided herein can be executed by programmable digital computer.

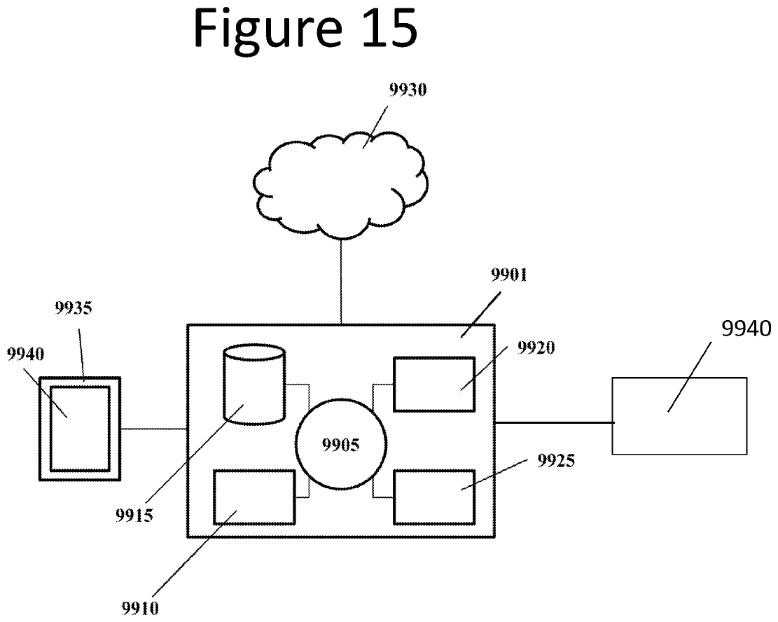

FIG. 15 shows an exemplary computer system. The computer system 9901 includes a central processing unit (CPU, also “processor” and “computer processor” herein) 9905, which can be a single core or multi core processor, or a plurality of processors for parallel processing. The computer system 9901 also includes memory or memory location 9910 (e.g., random-access memory, read-only memory, flash memory), electronic storage unit 9915 (e.g., hard disk), communication interface 9920 (e.g., network adapter) for communicating with one or more other systems, and peripheral devices 9925, such as cache, other memory, data storage and/or electronic display adapters. The computer readable memory 9910, storage unit 9915, interface 9920 and peripheral devices 9925 are in communication with the CPU 9905 through a communication bus (solid lines), such as a motherboard. The storage unit 9915 can be a data storage unit (or data repository) for storing data. The computer system 9901 can be operatively coupled to a computer network (“network”) 9930 with the aid of the communication interface 9920. The network 9930 can be the Internet, an internet and/or extranet, or an intranet and/or extranet that is in communication with the Internet. The network 9930 in some cases is a telecommunication and/or data network. The network 9930 can include one or more computer servers, which can enable distributed computing, such as cloud computing.

The CPU 9905 can execute a sequence of machine-readable instructions, which can be embodied in a program or software (code). The instructions may be stored in a memory location, such as the computer readable memory 9910. The instructions can be directed to the CPU 9905, which can subsequently program or otherwise configure the CPU 9905 to implement methods of the present disclosure.

The storage unit 9915 can store files, such as drivers, libraries, and saved programs. The storage unit 9915 can store user data, e.g., user preferences, log files, video or other images, and user programs. The computer system 9901 in some cases can include one or more additional data storage units that are external to the computer system 9901, such as located on a remote server that is in communication with the computer system 9901 through an intranet or the Internet.

The computer system 9901 can communicate with one or more remote computer systems through the network 9930.

Methods as described herein can be implemented by way of machine (e.g., computer processor) executable code stored on an electronic storage location of the computer system 9901, such as, for example, on the computer readable memory 9910 or electronic storage unit 9915. The machine executable or machine-readable code can be provided in the form of software. During use, the code can be executed by the processor 9905. In some cases, the code can be retrieved from the storage unit 9915 and stored on the memory 9910 for ready access by the processor 9905. In some situations, the electronic storage unit 9915 can be precluded, and machine-executable instructions are stored on memory 9910. The code can be used to communicate and issue instructions to electronic devices, e.g., circuit boards 9940, modules, or subsystems, on the instrument, for example, the rotary DC motor relay board 2134 or the heater relay board 2240 driving peltier 1420 to accomplish tasks such as rotating a motor or controlling the temperature of the cartridge 200.

The computer system 9901 can communicate with one or more remote computer systems through the network 9930.

Methods as described herein can be implemented by way of machine (e.g., computer processor) executable code stored on an electronic storage location of the computer system 9901, such as, for example, on the computer readable memory 9910 or electronic storage unit 9915. The machine executable or machine-readable code can be provided in the form of software. During use, the code can be executed by the processor 9905. In some cases, the code can be retrieved from the storage unit 9915 and stored on the memory 9910 for ready access by the processor 9905. In some situations, the electronic storage unit 9915 can be precluded, and machine-executable instructions are stored on memory 9910. The code can be used to communicate and issue instructions to electronic devices, e.g., circuit boards 9940, modules, or subsystems, on the instrument, for example, the rotary DC motor relay board 2134 or the heater relay board 2240 driving peltier 1420 to accomplish tasks such as rotating a motor or controlling the temperature of the cartridge 200.

Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks.

The computer system 9901 can include or be in communication with an electronic display 9935 that comprises a user interface (UI) 9940 for providing, for example, input parameters for methods described herein. Examples of UIs include, without limitation, a graphical user interface (GUI) and web-based user interface.

### Example 1: A Single-Sample Tissue Processing System to Single Cell and Nuclei Suspensions

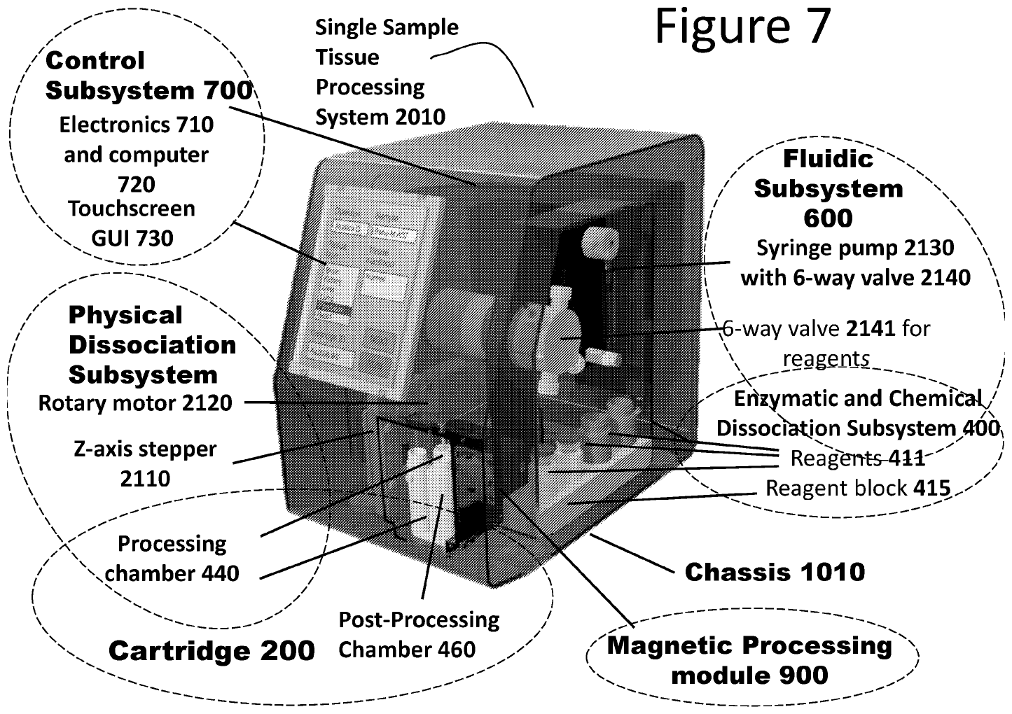

The Tissue Processing System 110 can deparafinize, rehydrate, and then mechanically disrupt tissue and enzymatically dissociate and reverse crosslinks of the disrupted tissue in a cartridge 200 into single nuclei 1050. As shown in FIG. 7, a Single Sample Tissue Processing System 2010 can combine the Physical Dissociation Subsystem 300 and the Enzymatic and Chemical Dissociation Subsystem 400 to produce single-cell 1000 or nuclei 1050 suspensions. The instrument provides the mechanical motion and fluidics to the cartridge which in turn mechanically and enzymatically or chemically process the FFPE tissue specimen 150 into single cells 1000 or nuclei 1050. Multiple reagents 411 can be stored on the instrument or reagent module 1430 with cooling as needed.

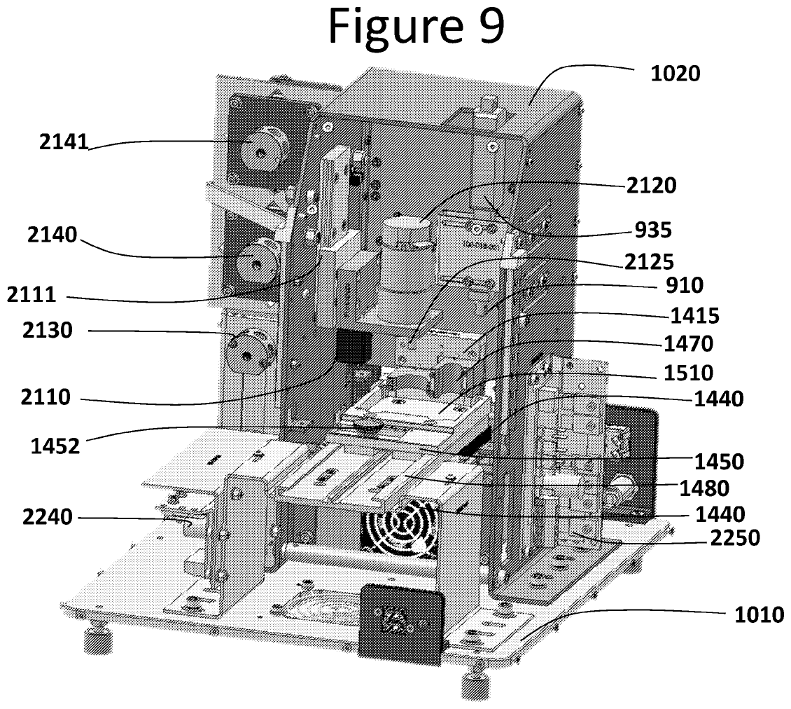

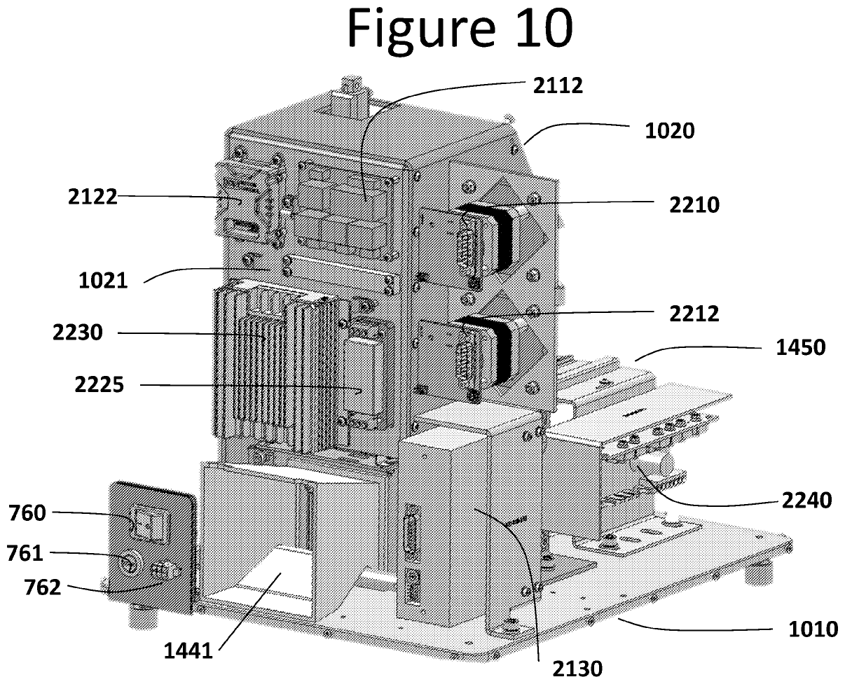

A 3D CAD representation of one embodiment of a Single-Sample Tissue Processing 2010 design packaged with a ‘skin’ is shown in FIG. 7 and another embodiment is shown in FIGS. 9 and 10. Both embodiments have a two axis mechanical motion (Z axis stepper 2110 and rotary motor 2120) integrated with fluidics based on a syringe pump, for example, with 1.6 μL resolution with a six-way valve (C2400MP, TriContinent) controlled by control software 725.

Referring to FIG. 7, a computer 720 with an operating system, for example, such as Windows 10 and 85 Gbytes HD (Beelink, AP42) can run control software 725 to control the system with display on a 10″ touchscreen 730 (eleduino, Raspberry Pi10) or on a tablet 750 such as a Windows Surface Pro 6. Chassis 1010 provides the framework to mount components and the exterior case of the system.

The embodiment of the Single-Sample Tissue Processing System 2000 shown in FIG. 7 has a fluidic subsystem 600 with a single syringe pump 2130 with a single six-way valve 2140 to supply liquids, pressure, or vacuum to cartridge 200 from reagent block 415. In one embodiment, cartridge 200 has two processing chambers 440 and a single post-processing chamber 460. In a preferred embodiment, magnetic processing module 900 can apply magnetic force to cartridge 200 under software control to enable the use of paramagnetic beads, paramagnetic surfaces, paramagnetic nanoparticles, and other magnetic or paramagnetic particles to purify and analyze single cells 1000, nuclei 1050, nucleic acids 1072, biomolecules 1070, subcellular components 1060, or other products.

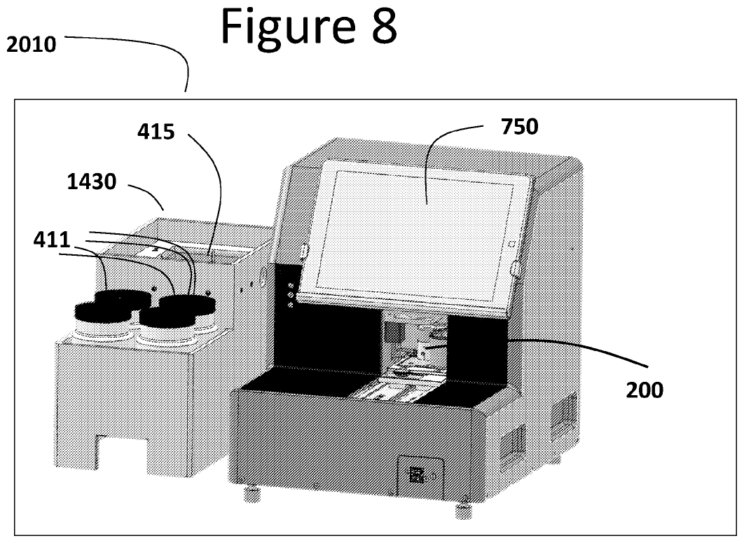

A preferred embodiment of the Single-Sample Tissue Processing 2010 with a case on is shown in FIG. 8. This embodiment has a reagent module 1430 which can be separate from Single Sample Tissue Processing Instrument 2010 as shown in FIG. 7 with power and control provided by Single Sample Tissue Processing Instrument 2010 or a separate power source and processor can be used, or as shown in FIG. 7 reagent module 1430 be integrated inside a single instrument case.

Referring to FIG. 9, in a preferred embodiment, Single Sample Tissue Processing Instrument 2010 has z-axis stepper motor 2110, which may have an optional encoder, that controls the vertical position of rotary motor 2120 mounted on z-axis stepper slide 2111 attached to the inverted ‘U’ shaped structural frame 1020 mounted on chassis 1010. A force gauge can be incorporated into the z-stage stepper 2110 to provide force-feedback control of the mechanical force on the specimen 101 or below cantilevered cartridge slide 1450; this can help ensure very gentle mechanical processing steps and prevent application of high force by the rotor 218 onto the bottom of processing chamber 440. Syringe pump 2130 connects fluidically with tubing or capillaries or microchips or other fluidic connectors with six-way valve 2141 and six-way valve 2142 to supply reagents, pressure, or vacuum to cartridge 200 (not shown) from reagent module 1430.

Cartridge 200 is placed into cartridge receiver tray 1510 on cartridge slide 1450 which is designed to hold cartridge 200 precisely, with the center of processing chamber 440 concentric with the center of rotary motor shaft 2121 of rotary motor 2120 within a distance or 1 or, 5, or 10, or 15, or 20, or 25, or 50, or 100, or 250 μm, or more when inserted by moving cartridge 200 in cartridge receiver tray 1510 on cartridge slide 1450 on cartridge slide rail 1480 until spring-loaded cartridge slide knob 1452 locks into place into a hole in cartridge slide 1450 with cartridge 200 held in place near or in contact with the thermal transfer plate 1470 and making fluidic connections with the pogo pins 1415 of cartridge interface 1500.

The temperature regulating subsystem 1475 can set the thermal transfer plate 1470 to a given temperature by cartridge Peltier 1440 or other temperature regulating device such as strip resistive heaters, circulating fluids, etc. to set the cartridge temperature in the processing chamber 440 and post-processing chamber 460 under control of board 2250. In some embodiments, the temperature of processing chamber 440 and post-processing chamber 460 can be set independently. In some embodiments the temperature regulating system can use a thermocouple, or thermistor, or IR camera to set the temperature of the thermal transfer plate 1470 or the outside of cartridge 200.

In a preferred embodiment, fluidic ports on cartridge 200 dock with spring-loaded pogo pins 1415 to connect fluids, gases, or vacuum to cartridge 200 on cartridge insertion. In another embodiment, pogo pins 1415 or cannula 1416 are moved to connect with cartridge 200 after cartridge insertion. In another embodiment, cannula 1416 connected to fluidic lines from syringe pump 2130 are held rigidly attached to the thermal transfer plate 1470 or other part of instrument and cartridge 200 has flexible materials on cartridge ports that seal with the cannula(s) 1416 after cartridge insertion, as described below. Cartridge ports are ports opening out of a cartridge. A cartridge port may communicate directly with a chamber by being a port in the chamber, or indirectly, e.g., through another chamber comprising the port and communicating with the chamber in question.

The embodiment of the single-sample Tissue Processing System 2010 shown in FIG. 9 has a Magnetic Processing Module 900 and magnet 910 is moved by magnetic actuator 935 mounted on inverted ‘U’ shaped structural frame 1020 under control of control software 725 using controller 2122. Magnet 910 can be far from cartridge 200 as shown in FIG. 9 and not interact with any magnetic beads 685 in cartridge 200 or in an extended position magnet 910 is moved to be near cartridge 200 for magnetic capture and processing of magnetic beads 685. Many embodiments of configurations of the geometric relationship of the Magnetic Processing Module 900 and magnet 910 and cartridge 200 are possible.

Referring to FIG. 10, in a preferred embodiment, the Single-Sample Singulator System 2000 has a back structural frame 1021 on structural frame 1020 that mounts electronics 710 comprising rotary motor controller 2122, z-axis stepper controller 2112, 24 V to 5 V step down power supply 2230 and 24 V to 12 V step down power supply 2225. Power can be supplied to single-sample Tissue Processing 2010 by plugging a 24 V power supply into plug 762 connecting to fuse 761 and power switch 760. Six way valves 2141 and 2142 are controlled by boards 2210 and 2212. Reagent Peltier relay board 2240 can control reagent Peltier 1420.

Systems that process one or more cartridges simultaneously are within the scope of the present invention. The cartridge 200 can have one or more Processing Chamber(s) 440 and none, one, or more Post-Processing Chamber(s) 460 as well as none, one or more other chambers such as cartridge waste chamber 435 or vacuum trap chamber 468.

In a preferred embodiment, illustrated in FIG. 11, cap 210, alternatively referred to as a tissue disruptor, is placed on top of processing chamber 440 after specimen 101 or FFPE tissue specimen 150 or OCT tissue sample 160 is added into processing chamber 440 of cartridge 200. After cartridge 200 is inserted into the instrument, pogo pins 1415, cannula 1416, or other fluidic connectors can connect with none, one, or more of cartridge ports 470 to supply reagents to processing chamber 440, cartridge port 485 to supply reagents or vacuum to post-processing chamber 460, cartridge vacuum trap port 467 to supply vacuum to vacuum trap chamber 468, or cartridge waste port 2355 to supply vacuum or reagents to cartridge waste line 2351.

A preferred embodiment of cartridge 200 for processing FFPE tissue specimen 150 or OCT tissue specimen 160 illustrated in FIG. 11 fluidically connects processing chamber 440 to post-processing chamber 460 using fluidic line 453, which can be tubing, connecting from processing chamber nipple 471 to lid nipple 452 positioned over strainer 2711 inserted into post-processing chamber 460. In other embodiments, no strainer can be used or strainer 2711 can be incorporated as an in-line filter, for example in a swinney filter holder 347 attached to the output of processing chamber 440 or in fluidic line 453 or attached to lid 462. In a preferred embodiment, dual or triple or more filters are used in strainer 2711, for example, a 145 micron filter followed by a 40 micron filter followed by a 20 micron filter; other combinations are envisioned.

Lid 462 produces a vacuum tight seal of post-processing chamber 460 and vacuum trap chamber 468 when cap 465 is sealed on lid 462. Lid 462 can be attached to cartridge body 201 by ultrasonic welding, glue, epoxy, adhesives, and other methods to produce a vacuum tight seal. The permanent attachment of lid 462 ensures single usage of cartridge 200 to eliminate cross sample contamination by preventing changing of strainer 2711.

In some embodiments, cartridge 200 can have on-cartridge valves which can be pinch valves 491 on fluidic lines such as fluidic line 453 which the instrument actuates to open and close lines, or by using a ‘T’ junction and two lines, rout fluids down different paths such as to on cartridge waste or to an a optics imaging system 520, or to multi'omics processing of another workflow or analysis method. In another embodiment, fluidic lines such as fluidic line 453 can be partially closed to create a variable orifice 2160 that can disrupt partially dissociated tissue. Actuators can open and pinch close tubing in the cartridge 200, or operate the variable orifice 2160 using variable orifice device 2150 when desired. In other embodiments, cartridge 200 can have on-cartridge valves which can be miniaturized pneumatic valves, or microvalves. In some embodiments, microfluidics or microchips are used for fluidic lines. In a preferred embodiment there are no valves on the cartridge 200 with all fluidic control from the instrument.

Processes described here can be performed using one or more computer systems that can be networked together. Calculations can be performed in a cloud computing system in which data on the host computer is communicated through the communications network to a cloud computer that performs computations and that communicates, or outputs results to a user through a communications network. For example, nucleic acid sequencing can be performed on sequencing machines located at a user site. The resulting sequence data files can be transmitted to a cloud computing system where the sequence classification algorithm performs one or more operations of the methods described herein. At any step cloud computing system can transmit results of calculations back to the computer operated by the user.

Data can be transmitted electronically, e.g., over the Internet. Electronic communication can be, for example, over any communications network include, for example, a high-speed transmission network including, without limitation, Digital Subscriber Line (DSL), Cable Modem, Fiber, Wireless, Satellite and, Broadband over Powerlines (BPL). Information can be transmitted to a modem for transmission, e.g., wireless or wired transmission, to a computer such as a desktop computer. Alternatively, reports can be transmitted to a mobile device. Reports may be accessible through a subscription program in which a user accesses a website which displays the report. Reports can be transmitted to a user interface device accessible by the user. The user interface device could be, for example, a personal computer, a laptop, a smart phone or a wearable device, e.g., a watch, for example worn on the wrist.

### Example 2: Processing FFPE Tissue into Nuclei or Cells

FFPE tissue is commonly used by pathologists to examine biopsy samples. Massive banks of FFPE tissue contain archives of tissue samples from many disease states including cancers. Currently, isolating single cells or nuclei from FFPE is challenging and not automated.

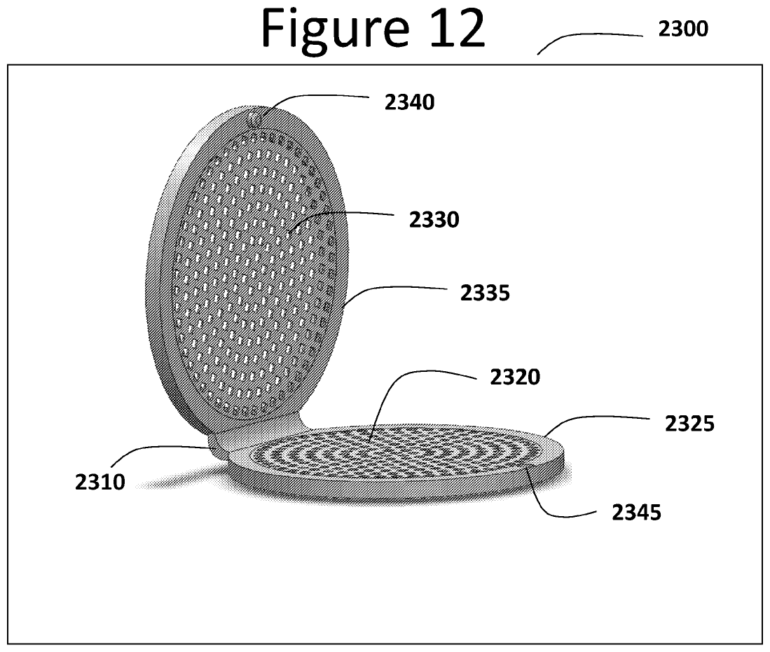

In one embodiment, one or more thin sections from an FFPE or OCT or other preserved block are added to tissue ring 2300 which can function to help retain the FFPE tissue specimen 150 or OCT tissue specimen 160 during processing. Referring to FIG. 12, in one embodiment tissue ring 2300 has a lower mesh 2320 attached to lower ring 2325 and an upper mesh 2330 attached to upper ring 2335. The lower ring 2325 and upper ring 2335 can be joined by hinge 2310. A FFPE tissue specimen 150 is inserted into tissue ring 2300 and then closed engaging snap 2340 with snap hole 2345 to close the tissue ring 2300 and hold the tissue between the upper and lower meshes. In some embodiments, the mesh has opening comprised of less then 500 mm, or less than 400, 300, 250, 200, 150, 100, 75, 50, 25, 20, 10, 5, 2, 1, or 0.5 mm. In some embodiments, the mesh is made from materials comprised of metals or plastics or composites, or paper, or laminates, or other materials. In some embodiments the mesh is a filter or strainer. In some embodiments the mesh is a porous material or a perforated material.

In some embodiments, the lower ring 2325 and upper ring 2335 are separate and, after the FFPE tissue specimen 150 or OCT tissue specimen 160 is placed upon lower ring 2325, the upper ring 2335 is attached by magnetic force or by features that snap together or hook and loop interactions, or other mechanical methods or by chemical interaction. In some embodiments the space between the rings where the tissue is held is in the range of 1, 2, 3, 4, 5, 10, 20, 25, 50, 75, 100, 125, 150, 200, 250, 500, 750, or 1,000 mm or larger.

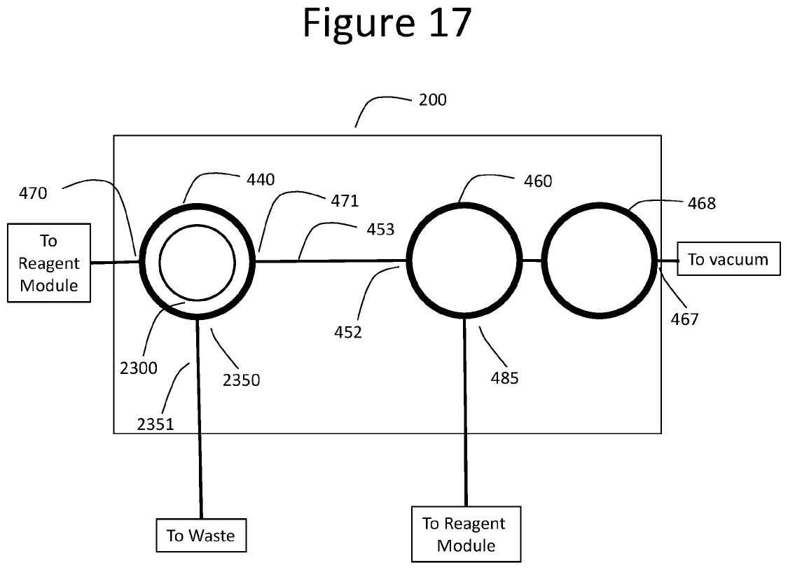

In a preferred embodiment, referring to FIG. 17, a tissue ring 2300 containing a tissue specimen can be placed in the processing chamber 440 of cartridge 200 which has a reagent addition port 470 that connects to reagents in reagent block 415 as part of reagent module 1430; a waste port 2350 that connects waste line 2351 to waste; a port 471 connecting flexible tubing 453 to port 452 of post-processing chamber 460. Post-processing chamber 460 is in turn connected to to reagents in reagent block 415 as part of reagent module 1430 through port 485 and also can contain or be connected to on cartridge vacuum trap 468 with port 467 which can connect to a vacuum source.

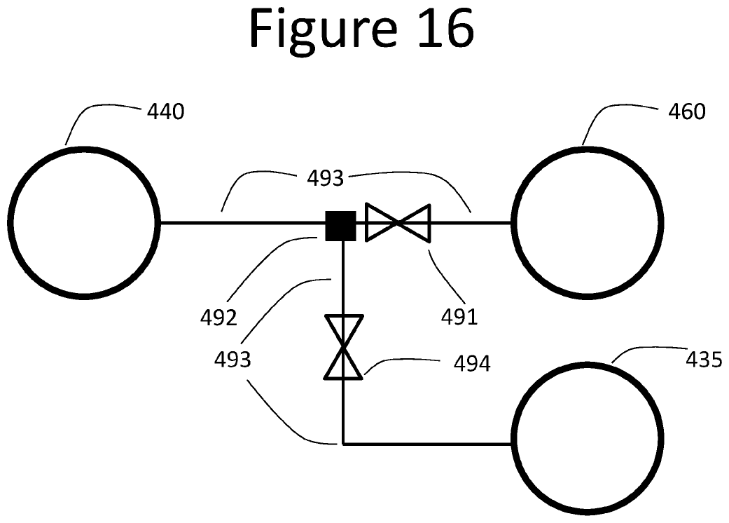

In one embodiments the waste is moved through additional ports or directed at valves, such as pinch valves 491, to on-cartridge waste 430. In one embodiment, illustrated in FIG. 16, processing chamber 440 is connected by flexible tubing 493 to three way junction 492 which is further connected by flexible tubing 493 to post-processing chamber 460 and cartridge waste chamber 435. Flow can be directed from processing chamber 440 to cartridge waste chamber 435 by closing pinch valve 491 while pinch valve 494 is open and applying vacuum to cartridge waste chamber 435. The cartridge waste chamber 435 can also be replaced by off cartridge waste as desired. Flow can be directed from processing chamber 440 to post-processing chamber 460 by opening pinch valve 491 while pinch valve 494 is closed and applying vacuum to post-processing chamber 460. Similar designs can be used to fluidically connect other devices such as flow cells, flow cytometry, nanodroplet single cell processors, sequencers, etc. as a device or module of the instrument.

In a preferred embodiment, as shown in FIG. 11, a FFPE tissue specimen 150 or OCT tissue specimen 160 is inserted into a tissue ring 2300 which is closed and then inserted into the processing chamber 440 of cartridge 200 through sample inlet port 425. The cap 210 is added and the cartridge 200 placed into an Tissue Processing instrument 2010. In some embodiments cartridge 200 has a filter added in or over the channel leading to the waste port 2350 to prevent loss of the FFPE or OCT thin sections to waste line 2351. In some embodiments, waste line 2351 has a pinch valve 491 to minimize the volume of liquid in the line. In other embodiments waste line 2351 has a T junction and one or more pinch valves 491 to direct the flow of liquid for example to an on-cartridge waste reservoir 430. In one embodiment, an FFPE tissue specimen 150 or OCT tissue specimen 160 is inserted into the bottom of processing chamber 440 on top of bottom filter added in or over the channel leading to the waste port 2350 and one side of mesh of a tissue ring is added to entrap the FFPE tissue specimen 150 or OCT tissue specimen 160 between bottom filter and one side of a tissue ring 2300.

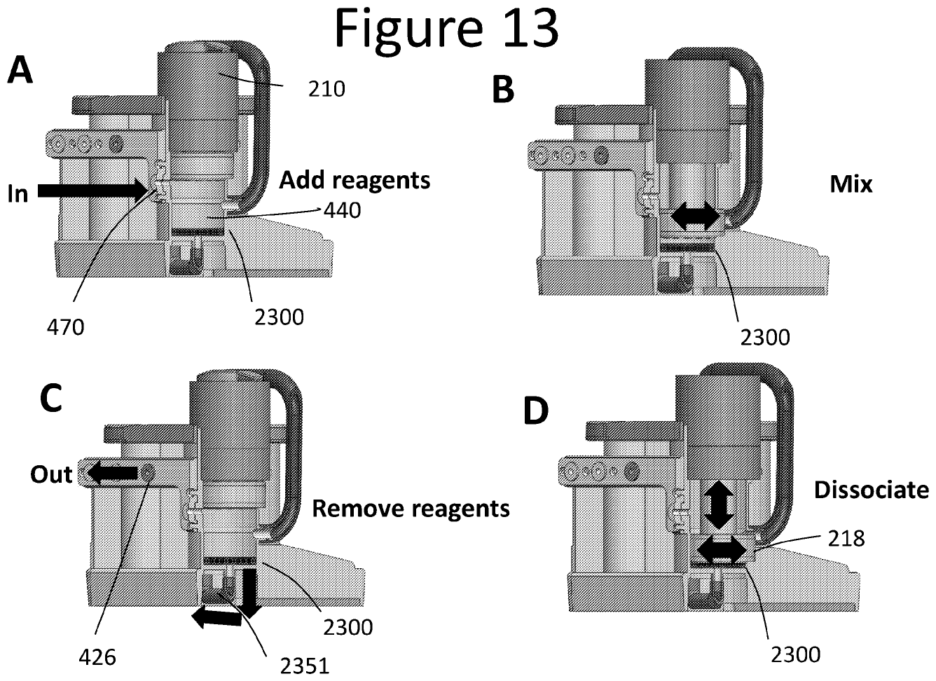

Selection of the appropriate cell or nuclei protocol for processing FFPE tissue specimens 150 and using the appropriate setup of reagent module 1430, as shown in FIGS. 11 and 13A, the instrument can add, for example, 2 mL of xylene from the reagent module 1430 to cartridge 200 through port 470 into processing chamber 440 containing FFPE tissue specimen 150 in tissue ring 2300. The xylene is then incubated for a time period selected from the range of 10 sec, 30 sec, 1 min, 5 min, 10 min, 15 min, 30 min or longer at room temperature. In some embodiments, as shown in FIG. 13B, rotor 218 is lowered into the xylene and rotated to circulate the xylene around the FFPE tissue specimen 150. In other embodiments the xylene is moved by changes of pressure applied through waste line 2351 through port 426 or liquid can be pumped in and out of waste line 2351 through port 426.

Referring to FIGS. 11 and 13C, vacuum is then applied to waste port 2355 and the xylene is then pulled from processing chamber 440 through waste channel 2350 and through waste line 2351 into the instrument. The FFPE tissue specimen 150 is retained in tissue ring 2300.

In some embodiments, the process is repeated two additional times with xylene, Xylol, histolene, and other compatible solvents can replace xylene. In other embodiments, a separate waste chamber is added and pinch valves 491 are used to direct flow either to a waste chamber 430 or processing chamber 460.

The instrument can then perform rehydration, for example, by adding two mL of 100% ethanol from the reagent module 1430 to cartridge 200 and incubating for a time period selected from the range of 10 sec, 30 sec, 1 min, 5 min, 10 min, 15 min, 30 min or longer at room temperature or other temperature. The 100% ethanol is then removed through waste channel 2350 and the process repeated none, one, or more additional times with 100% ethanol.

The instrument can add 2 mL of 70% ethanol from the reagent module 1430 to cartridge 200 and incubate for a time period selected from the range of 10 sec, 30 sec, 1 min, 5 min, 10 min, 15 min, 30 min or longer at room temperature or other temperature. The 70% ethanol is removed through waste channel 2350 and the process repeated none, one, or more additional times with 70% ethanol.

The instrument can add 2 mL of 50% ethanol from the reagent module 1430 to cartridge 200 and incubate for a time period selected from the range of 10 sec, 30 sec, 1 min, 5 min, 10 min, 15 min, 30 min or longer at room temperature or other temperature. The 50% ethanol is removed through waste channel 2350 and the process repeated none, one, or more additional times with 50% ethanol. In some embodiments, a 30% ethanol step or other additional reverse sequential ethanol wash steps can be added. In some embodiments, the ethanol washes and other solutions can be supplemented with PBS, bovine serum albumin, RNAse inhibitors, protease inhibitors, or other supplements.

The instrument can add 2 mL of purified water, such as double distilled water with RNAse inhibitors, or 2 mL of buffer from the reagent module to cartridge 200 and incubate for a time period selected from the range of 10 sec, 30 sec, 1 min, 5 min, 10 min, 15 min, 30 min, 60 min, 2 hours, 4 hours, 8 hours, 12 hours, 24 hours at at 4° C., room temperature or other temperatures. The water is then removed through waste channel 2350 and the process repeated none, one, or more additional times with purified water.

In some embodiments the addition of the redyrating solutions or other liquids can be a gradient and can be intermittent or a continuous gradient over a time period selected from the range of 10 sec, 30 sec, 1 min, 5 min, 10 min, 15 min, 30 min, 60 min, 2 hours, 4 hours, 8 hours, 12 hours, 24 hours at at 4° C., room temperature or other temperatures.

The deparaffinized rehydrated FFPE tissue specimen 150 can have an optional crosslink reversal step. In one method, an enzymatic digestion is performed by adding up to two mL of proteinase K solution (0.005% proteinase K, 30 U/mg protein, in 50 mM Tris hydroxymethyl aminomethane hydrochloride (pH 7.0), 10 mM EDTA, and 10 mM sodium chloride), with optional DNase addition, and incubating for a time period selected from the range of 1 min, 5 min, 10 min, 15 min, 30 min, 60 min, 2 hours, 4 hours, 8 hours, 12 hours, 24 hours at 37° C., or up to 60° C., or other temperatures. The proteinase solution is then removed through waste channel 2350. Other methods such as heating the deparaffinized rehydrated FFPE can also be employed to reverse crosslinking.

In a preferred embodiment, nuclei are produced from the deparaffinized rehydrated FFPE tissue specimen 150 or OCT tissue specimen 160 are held in tissue ring 2300. 2 mL of nuclei isolation buffer 412, such as NST buffer (146 mM NaCl, 10 mM Tris base at pH 7.8, 1 mM CaCl₂, 21 mM MgCl2, 0.05% BSA, 0.2% Nonidet P-40) can be be added and incubated for a time period selected from the range of 1 min, 5 min, 10 min, 15 min, 30 min, 60 min, 2 hours, 4 hours, 8 hours, 12 hours, or 24 hours. As shown in FIG. 13D, in one embodiment, the rotor 218 can then be lowered and rotated to mechanically disrupt the deparaffinized rehydrated FFPE tissue specimen 150 held in tissue ring 2300 using grinding teeth 355.

With the rotor 218 lowered, the released nuclei 1050 suspension is then pulled by vacuum applied to vacuum trap port 467 through fluidic line 453 through an optional filter(s) into post-processing chamber 460. In a preferred embodiment, dual filters of 150 microns followed by 40 microns are used. In other embodiment three or more filters such as 150 microns followed by 40 microns followed by 20 microns are used.

2 mL of a nuclei storage buffer 413 without detergent can be added to processing chamber 420 and incubated for a time period selected from the range of 1 min, 5 min, 10 min, 15 min, 30 min, 60 min, 2 hours, 4 hours, 8 hours, 12 hours, or 24 hours. Nuclei storage buffer 413 can contain materials to buffer pH, maintain osmolarity, and inhibit RNA degradation. One example of a nuclei storage buffer contains 73 mM NaCl, 5 mM Tris-HCl pH 7.5, 0.5 mM CaCl₂, and 1.05 mM MgCl₂. As desired this wash step with nuclei storage buffer 413 can be repeated and the rotor used to circulate the nuclei storage buffer 413.

The released nuclei 1050 suspension in nuclei storage buffer 413 in some embodiments can now pass through the pores in tissue ring 2300 or filter basket 2350 and is then pulled into the through fluidic line 453 through an optional filter(s) into post-processing chamber 460.

The cartridge can then be released from the instrument and seal 465 on the lid of the post-processing chamber 460 opened to pipette out the released nuclei 1050 suspension or if the nuclei or cell produced cannot pass through the pores of the tissue ring 2300 or filter basket 2350, they are removed and the material recovered. The suspension can be centrifuged for example at 500 rpm for 5 minutes, and resuspended in nuclei storage buffer 413, and optionally again filtered through a 40 μm or other filter. Additional processing can then be performed as appropriate for downstream procedures. In other processing the released nuclei 1050 suspension can be flow sorted to purify intact nuclei from debri.

In an alternate embodiment, if cells are to be produced from the deparaffinized rehydrated FFPE tissue specimen 150, 2 mL of a solution to dissolve residual extracellular matrix can be added such as formulations of a reagents or mixture of components comprised of but not limited to collagenases (e.g., collagenases type I, II, III, IV, and others), elastase, trypsin, papain, hyaluronidase, chymotrypsin, neutral protease, clostripain, caseinase, neutral protease (Dispase®), DNAse, protease XIV, RNase inhibitors, or other enzymes, biochemicals, or chemicals such as EDTA, protease inhibitors, buffers, acids, or base. In one embodiment, two mL of an enzymatic cocktail containing 1 mg/ml of Collagenase/Dispase (Roche) and 100 units/ml of Hyaluronidase (Calbiochem) in PBS/0.5 mM CaCl₂ are added with optional DNase addition and incubated for a time period selected from the range of 1 min, 5 min, 10 min, 15 min, 30 min, 60 min, 2 hours, 4 hours, 8 hours, 12 hours, 24 hours at 37° C., or other temperatures. The released single cell 1000 or single nuclei 1050 suspension is then pulled into the processing chamber 460 through a filter which may be a dual filter with a 150 mm filter followed by a 70 mm filter or other set of filters.

In one process nuclei suspensions can be produced from FFPE tissue specimens 150 by deparaffinization, rehydration, enzymatic digestion/crosslink reversal or chemical dissociation with mechanical disruption, and filtration. Direct nuclei extraction of deparaffinized, rehydrated tissues with a detergent-based formulation can be employed either in place of or following an enzymatic digestion. A range of embodiments of processes with a range of incubation times, with and without mixing, is possible.

The processes can be in cartridges in, for example, two mL volumes. Sections of 5, 10, 20, 30, and 50 □m can be processed to optimize the thickness to recover intact nuclei. Dewaxing issues can be found with thicker slices. Incubation times, temperatures, and number of cycles for deparaffinization can be varied and xylene replacement formulations used (e.g., CitriSolv, HistoChoice, NeoClear, Ultraclear, Qiagen Deparaffinization Solution). For sample rehydration, successive ethanol incubations of decreasing concentration are needed. In addition to stepwise ethanol concentration reduction, the instrument fluidics can produce a continuous gradient between ethanol and other mixture components, to optimize the impact on the tissue, shorten the rehydration and other process times. The continuous gradient mode can improve the nuclei or cell morphology, yield, and RNA quality compared to the standard stepwise gradients.

Direct conversion of rehydrated tissue with or without crosslink reversal into nuclei can be achieved using a detergent-based nuclei isolation solution, either in place of enzymatic dissociation or as a subsequent step to the enzymatic dissociation. A range of different detergents such as Triton X-100, NP-40, or SDS at varying concentrations from 0.1-5% in osmoprotectants can used with rehydrated samples or after crosslink removal with a range of incubation times and mechanical disruption intensities.

Crosslink reversal can employ Proteinase K to reversing of crosslinks and digest cellular membranes. Other reagents (e.g., Tris-EDTA, IHC antigen retrieval reagent, Enzo) and temperatures up to 90° C. can be used. For enzymatic dissociation, enzymatic formulations and processes to digest extracellular matrices and free cells from fresh, frozen, or OCT human, mouse, and rat tissues are comprised of Proteinase K, pepsin, Collagenase/Dispase (Roche), hyaluronidase, an enzyme cocktail (collagenase type 3, purified collagenase, and hyaluronidase), and other formulations.

### Example 3: Processing OCT Tissue into Nuclei or Cells

After selection of the appropriate cell or nuclei protocol for processing OCT tissue specimens 160 and using the appropriate setup of reagent module 1430, as shown in FIGS. 11 and 13A, the instrument can add, for example, 2 mL of a buffer such as PBS or other rinse reagent from the reagent module 1430 to cartridge 200 through port 470 into processing chamber 440 containing OCT tissue specimen 160 in tissue ring 2300. The PBS is then incubated for a time period selected from the range of 10 see, 30 sec, 1 min, 5 min, 10 min, 15 min, 30 min or longer at room temperature. In some embodiments, as shown in FIG. 13B, rotor 218 is lowered into the PBS and rotated to circulate the PBS around the OCT tissue specimen 160. In other embodiments the PBS is moved by changes of pressure applied through waste line 2351 through port 426 or liquid can be pumped in and out of waste line 2351 through port 426.

Referring to FIGS. 11 and 13C, vacuum is then applied to waste port 2355 and the PBS is then pulled from processing chamber 440 through waste channel 2350 and through waste line 2351 into the instrument. The OCT tissue specimen 160 is retained in tissue ring 2300. In other embodiments the waste is moved through additional ports or directed at valves, such as pinch valves, to on cartridge waste 430.

In some embodiments, the process is repeated two additional times with the PBS, HBSS, TBS, HEPES, or other aqueous buffers in the pH range 6.0-8.0, or other compatible non-aqueous rinse reagents such as methanol can replace PBS individually or used sequentially in combination. In other embodiments, a separate waste chamber is added and pinch valves 491 are used to direct flow either to a waste chamber 430 or processing chamber 460.

In a preferred embodiment, nuclei are produced from the OCT tissue specimen 160 held in tissue ring 2300. 2 mL of a nuclei isolation buffer 412, such as NST buffer (146 mM NaCl, 10 mM Tris base at pH 7.8, 1 mM CaCl₂, 21 mM MgCl₂, 0.05% BSA, 0.2% Nonidet P40) can be be added and incubated for a time period selected from the range of 1 min, 5 min, 10 min, 15 min, 30 min, 60 min, 2 hours, 4 hours, 8 hours, 12 hours, or 24 hours. As shown in FIG. 13D, in one embodiment, the rotor 218 can then be lowered and rotated to mechanically disrupt the OCT tissue specimen 160 held in tissue ring 2300 using grinding teeth 355.

With the rotor 218 lowered, the released nuclei 1050 suspension is then pulled by vacuum applied to vacuum trap port 467 through fluidic line 453 through an optional filter(s) into post-processing chamber 460. In a preferred embodiment, dual filters of 150 microns followed by 40 microns are used. In other embodiment three or more filters such as 150 microns followed by 40 microns followed by 20 microns are used.

2 mL of a nuclei storage buffer 413 without detergent can be added to processing chamber 420 and incubated for a time period selected from the range of 1 min, 5 min, 10 min, 15 min, 30 min, 60 min, 2 hours, 4 hours, 8 hours, 12 hours, or 24 hours. Nuclei storage buffer 413 can contain materials to buffer pH, maintain osmolarity, and inhibit RNA degradation. One example of a nuclei storage buffer containing 73 mM NaCl, 5 mM Tris-HCl pH 7.5, 0.5 mM CaCl₂), and 1.05 mM MgCl₂. The released nuclei 1050 suspension in nuclei storage buffer 413 is then pulled into the through fluidic line 453 through an optional filter(s) into post-processing chamber 460.

The cartridge can then be released from the instrument and seal 465 on the lid of the post-processing chamber 460 opened to pipette out the released nuclei 1050 suspension. The suspension can be centrifuged for example at 500 rpm for 5 minutes, and resuspended in nuclei storage buffer 413, and optionally again filtered through a 40 μm or other filter(s). Additional processing can then be performed as appropriate for downstream procedures. In other processing the released nuclei 1050 suspension can be flow sorted to purify intact nuclei from debri.

In an alternate embodiment, if cells are to be produced from the OCT tissue specimen 160, after rinsing with PBS or other buffer, 2 mL of a solution to dissolve residual extracellular matrix can be added such as formulations of a reagents or mixture of components comprised of but not limited to collagenases (e.g., collagenases type I, II, III, IV, and others), elastase, trypsin, papain, hyaluronidase, chymotrypsin, neutral protease, clostripain, caseinase, neutral protease (Dispase®), DNAse, protease XIV. RNase inhibitors, or other enzymes, biochemicals, or chemicals such as EDTA, protease inhibitors, buffers, acids, or base. In one embodiment, two mL of an enzymatic cocktail containing 1 mg/ml of Collagenase/Dispase (Roche) and 100 units/ml of Hyaluronidase (Calbiochem) in PBS/0.5 mM CaCl₂ are added with optional DNase addition and incubated for a time period selected from the range of 1 min, 5 min, 10 min, 15 min, 30 min, 60 min, 2 hours, 4 hours, 8 hours, 12 hours, 24 hours at 37° C., or other temperatures. The released single cell 1000 suspension is then pulled into the processing chamber 460 through a filter which may be a dual filter with a 150 mm filter followed by a 70 mm filter or other set of filters.

Process metrics for preparing FFPE tissue specimens 150 or OCT tissue specimens 160 can be produced on device or on other instruments and include fluorescent microscopy of DAPI stained preparations to visualize nuclei: nuclei yield measurements by automated counting: one step ACTB RT-qPCR with 3′ and 5′ primers to assess RNA quality of single nuclei suspensions; and bulk sequencing. For RT-qPCR and bulk DNA sequencing of FFPE DNA and RNA from a given step can be extracted with a reagent such as AllPrep DNA/RNA FFPE Kit (Qiagen). Bulk mRNA nuclei sequencing can be performed using the SMART-Seq® v4 Ultra® Low Input RNA Kit for Sequencing (Takara Bio) with gel electrophoresis (High Sensitivity chip, Bioanalyzer) to characterize the size distribution and Nextera library preparation.

Single nuclei sequencing can be performed by methods comprised of SMARTSeq and nanodrop snRNA-Seq. SMARTSeq exhibits more uniform transcriptome coverage with lower numbers of nuclei. For SMARTSeq, individual nuclei can be isolated, transferred into individual wells of a microtiter plate on ice, and cDNA prepared using the SMART-Seq® Single Cell Kit (Takara Bio). The yield and quality of nuclei suspensions can be tested using qPCR on the ACTB gene. The snRNA-Seq approach can use nanodrops to encapsulate the nuclei and perform library preparation. The amount and quality of the cDNA can be measured by qPCR of ACTB and by electrophoresis to determine if the cDNA has an appropriate size range, is free of contaminating small fragments, and present in sufficient yield for Nextera (Illumina) or other library preparation. Sequence data metrics include percent of uniquely mapped reads, mapping rates of reads (exonic, intronic, intergenic), read coverage uniformity, mtDNA contamination, cell type-specific marker genes to measure cell type diversity of the resulting single nuclei populations, and principal component and hierarchical clustering analyses.

### Example 4: Rotating Filter Basket

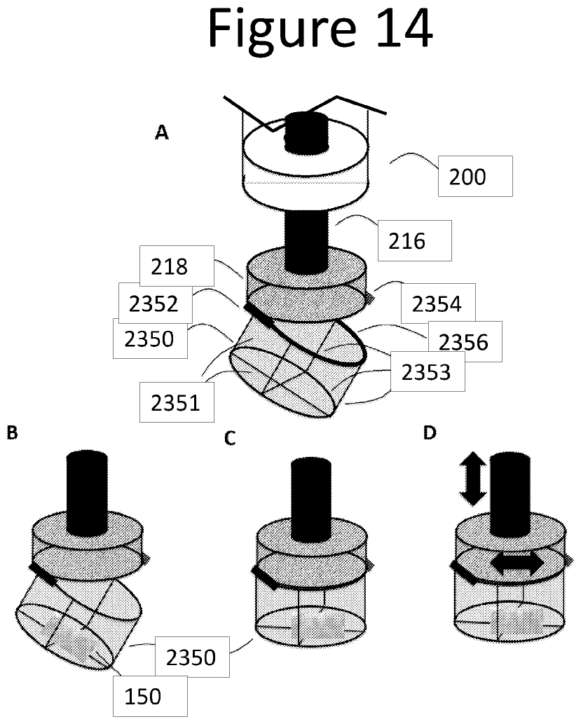

In another preferred embodiment, a filter basket 2350 is used. As shown in FIG. 14A, in one embodiment, a filter basket 2350 is attached by a hinge 2352 to the bottom of rotor 218. The filter basket 2350 can have a barrier material 2351 comprised of a mesh, filter, strainer, fabric, membrane, porous material, etc. covering the bottom or one or more sides. Different barrier material 2351 with different properties can be used on different sides. Filter basket 2350 can have, for example, 40-100 mm nylon mesh with reinforced polypropylene edges as a flat bottom with nylon mesh panels on the side supports 2353 attached by methods including ultrasonic welding, adhesives, thermal bonding, solvent bonding and other methods.

The filter basket 2350 can be connected to cap 210 and rotor 218 by a hinge 2352 and clasp 2354. In some embodiments clasp 2354 is a magnetic clasp. As shown in FIG. 14B, one or more FFPE tissue specimens 150 or OCT tissue specimens 160 are placed inside of the filter basket 2350. When filter basket 2350 is closed, as shown in FIG. 14C, O-rings 2356 can completely seal the filter basket 2350 chamber to prevent dissociated FFPE tissue specimen 150 or OCT tissue specimens 160 material from being removed as waste before it is processed in single nuclei 1050 or other biological materials.

The cap 210 with attached filter basket 2350 and FFPE tissue specimens 150 or OCT tissue specimens 160 or other tissue specimens loaded is inserted into cartridge 200, closing the sample inlet port 425 (the top opening of processing chamber 440). By moving the rotor 218 in cap 210 up and down, or rotating, filter basket 2350 can be submerged in various chemicals and enzymes in many different embodiments to dissociate and isolate nuclei. As shown in FIG. 14D, filter basket 2350, connected to rotor 218, can be rotated and raised or lowered by the instrument.

In one embodiment, the processes such as described above for the process described above in the tissue ring example can be used. An advantage of the filter basket 2350 embodiment is tissue specimen 150 or OCT tissue specimens 160 or other tissue specimens held inside the basket, can be lowered into processing chamber 440 and incubated with Xylene, alcohol, buffers, chemicals, and enzymes, and then raised out of the liquid when a buffer exchange is needed. The now waste fluids can be removed through waste channel 2350 when needed. The filter basket 2350 can be rotated in the processing chamber 440 to fully remove liquids from the sample. The filter basket 2350 would enables FFPE tissue specimen 150 or OCT tissue specimens 160 or other tissue specimens to be raised above the fluidic input port, allowing the processing chamber 440 to be rinsed with water, solvents, or other liquids in-between steps if desired. Spinning and moving the basket in liquids can further dissociate tissue samples after enzymatic treatments. Following dissociation steps, nuclei released from tissue slices would then be able to pass through the, for example, 40 micron mesh sides and bottom of the basket allowing the nuclei to be separated from undissociated tissue and debris.

### Exemplary Embodiments

1. A method of processing preserved tissue, comprising:
a) providing a sample of preserved tissue in a closed, porous container that allows liquid flow through the pores;
b) inserting the container with preserved tissue into a processing chamber of a cartridge and engaging the cartridge with an instrument;
c) processing the tissue to remove preservative compounds by introducing, one or more times, a processing solution from the instrument into the processing chamber, to produce processed tissue, and removing processing solutions from the processing chamber.

2. The method of embodiment 1, wherein the preserved tissue comprises formalin fixed paraffin-embedded (“FFPE”) tissue, wherein processing comprises:
deparaffinizing the tissue by introducing, one or more times, a deparaffinizing solution from the instrument into the processing chamber, to produce de-paraffinized tissue, and removing deparaffinizing solutions from the processing chamber; and
re-hydrating the deparaffinized tissue by introducing one or more re-hydrating solutions from the instrument into the processing chamber, to produce rehydrated tissue, and removing the rehydrating solutions from the processing chamber: and
optionally, reversing crosslinks in the rehydrated tissue by heating the processing chamber, applying ultrasonic energy to the processing chamber, or introducing one or more enzymes or chemicals from the instrument into the processing chamber, to produce un-crosslinked tissue, and removing the enzymes or chemicals from the processing chamber: and
optionally, recovering the processed tissue from the container.

3. The method of embodiment 1, wherein the preserved tissue comprises optimal cutting temperature (“OCT”) tissue, wherein processing comprises:
removing OCT compounds by introducing, one or more times, one or more rinse reagents from the instrument into the processing chamber, to produce processed tissue, and removing rinse reagents from the processing chamber; and
optionally, recovering the rinsed tissue from the container

4. The method of any of the preceding embodiments, further comprising:
releasing cells and/or nuclei from the processed tissue mechanically and/or enzymatically or chemically in the processing chamber.

5. The method of embodiment 4, further comprising:
separating the cells and/or nuclei from debris or aggregates by passing the released cells and/or nuclei from the processing chamber through a strain chamber comprising a strainer and into a processing chamber.

6. The method of embodiment 5, comprising recovering cells from the processing chamber.

7. The method of embodiment 5, comprising recovering nuclei from the processing chamber.

8. The method of embodiment 4, wherein releasing cells and/or nuclei from the tissue comprises:
placing the recovered tissue into processing chamber;
introducing a mechanical tissue disruptor into the processing chamber, and mechanically disrupting the tissue to release cells and/or nuclei.

9. The method of embodiment 4, wherein releasing cells and/or nuclei from the tissue comprises:
mechanically deforming the porous container in the processing chamber.

10. The method of embodiment 4, wherein releasing cells and/or nuclei from the tissue comprises:
introducing enzymes and/or chemicals into the processing chamber to disrupt extracellular matrix.

11. The method of embodiment 1, wherein the porous container is configured as a ring having an upper portion and a lower portion which, when mated, define a space for receiving an FFPE tissue sample.

12. The method of embodiment 11, wherein the porous container comprises a mesh.

13. The method of embodiment 11, wherein the upper portion is attached to the lower portion, e.g., through a hinge.

14. The method of embodiment 11, wherein the ring comprises a snap for closing the ring.

15. The method of embodiment 11, wherein the upper portion and lower portion close by magnetic attraction.

16. The method of embodiment 1, wherein the porous container is configured as an assembly comprising a basket and a lid, wherein the basket has an open top that is closed by the lid, the lid is attached to a plunger, wherein the assembly fits into the processing chamber.

17. The method of embodiment 16, wherein the basket is attached to the plunger via a hinge.

18. The method of embodiment 16, wherein the assembly is closed by a magnet or a clasp.

19. The method of embodiment 16, wherein the cap seals the basket through an “o” ring.

20. The method of embodiment 16, wherein the basket comprises a mesh, e.g., a nylon mesh.

21. The method of embodiment 12 or embodiment 20, wherein the mesh has perforations no greater than any of 500 microns, 400 microns, 300 microns, 250 microns, 200 microns, 150 microns, 100 microns, 75 microns, 50 microns, 25 microns, 20 microns, 10 microns, 5 microns, 2 microns, 1 microns, or 0.5 microns.

22. The method of any of embodiments 1-10, wherein the enzymes or chemicals comprise one or more of a protease, a collagenase, a hyaluronidase, an elastase, an osmoprotectant, a DNase, a protease inhibitor, a nuclease inhibitor, a detergent, and a buffer.

23. The method of embodiment 1, wherein the deparaffinizing solution comprises xylene, xylol, or histolene.

24. The method of embodiment 1, wherein deparaffinizing comprises regulating temperature of the processing chamber.

25. The method of embodiment 1, wherein the one or more re-hydrating solutions comprise aqueous solutions of ethanol at decreasing concentrations, and/or H2O.

26. The method of embodiment 1, wherein the tissue is not mounted on a slide.

27. The method of any of the foregoing embodiments, wherein the cartridge comprises:
(i) a processing chamber;
wherein the processing chamber comprises a floor, a side wall, and a top orifice, first and second processing chamber ports positioned in the side wall, and a third processing chamber port positioned in the floor;
(ii) a rotor assembly comprising a cap and a plunger,
wherein the cap is positioned in the orifice;
wherein the plunger comprises a piston and a distal rotor and is slidably positioned in the processing chamber through the cap;
(iii) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE or OCT tissue sample); or
(B) an assembly comprising a basket and a lid, wherein the basket has an open top that is closed by the lid, and the lid comprises the rotor;
(iv) a strain chamber comprising a strainer having pores no greater than about 40 microns (e.g., no greater than about 20 microns), and an optional second strainer having pores no greater than about 200 microns;
wherein the strain chamber communicates with the processing chamber through the second processing port;
(v) a waste port that communicates with the third processing chamber port;
(vi) a post-processing chamber comprising:
a first post-processing chamber port that communicates with the strain chamber, and
a second post-processing chamber port, and
a third post-processing chamber port; and
(vii) a vacuum trap comprising:
a first vacuum trap port that communicates with the post-processing chamber through the second post-processing chamber port; and
a second vacuum trap chamber port.

28. The method of embodiment 27, wherein the rotor of the plunger is biased toward the cap (e.g., spring biased).

29. The method of embodiment 27,
wherein deparaffinizing comprises:
(i) introducing the deparaffinizing solution into the processing chamber through the first processing port from a chamber in the reagent module; and
(ii) removing the deparaffinizing solution from the processing chamber through the processing third port;
wherein re-hydrating comprises:
(i) introducing the re-hydrating solutions into the processing chamber through the first processing port from one or more chambers in the reagent module; and
(ii) removing the re-hydrating solutions from the processing chamber through the third processing port; and
wherein optionally reversing crosslinks in the rehydrated tissue comprises:
(i) introducing an enzyme solution comprising the one or more enzymes into the processing chamber through the first processing port from one or more chambers in the reagent module: and
(ii) removing the one or more enzymes from the processing chamber through the third processing port.

30. The method of embodiment 29, further comprising mixing the solutions in the processing chamber by moving the plunger up and down along a Z axis and/or rotating the plunger around the Z axis, in the processing chamber.

31. The method of embodiment 29, wherein the second processing port communicates with the post-processing chamber through a port in a cap of the post-processing chamber.

32. The method of embodiment 31, wherein the rotor has sufficient clearance from the processing chamber walls to allow liquid, cells and nuclei to pass around the rotor during depression, the second processing port is positioned above the rotor when fully depressed, and removing solution comprises depressing the rotor and applying negative pressure to the vacuum port.

33. The method of embodiment 29, wherein the porous container is configured as an assembly comprising a basket and a lid, wherein the basket has an open top that is closed by the lid, the lid is attached to the plunger, wherein the assembly fits into the processing chamber, and wherein moving the plunger up and down along the Z axis moves the basket up and down through the solution.

34. The method of embodiment 27,
wherein removing OCT compounds comprises:
(i) introducing, one or more times, rinsing reagents into the processing chamber through the first processing port from a chamber in the reagent module; and
(ii) removing the rinsing reagents from the processing chamber through the processing third port.

35. The method of method of embodiment 27, wherein mechanically disrupting comprises:
(i) introducing a disruption solution into the processing chamber through the first processing port from a chamber in the reagent module; and
(ii) grinding the tissue recovered from the porous container against the floor by moving the plunger up and down along a Z axis and/or rotating the plunger around the Z axis, in the processing chamber.

36. The method of method of embodiment 27, wherein mechanically disrupting comprises:
(i) introducing a disruption solution into the processing chamber through the first processing port from a chamber in the reagent module; and
(ii) deforming the porous container containing the tissue with the plunger to disrupt the tissue.

37. The method of method of embodiment 27, wherein mechanically disrupting comprises:
(i) introducing a disruption solution into the processing chamber through the first processing port from a chamber in the reagent module; and
(ii) rotating and moving up and down, the assembly comprising the basket in the disruption solution.

38. The method of embodiment 35, wherein recovering the cells and/or nuclei comprises moving released cells and/or nuclei from the processing chamber, through the second processing port, through the fluidic channel and into the post-processing chamber; wherein the cells and/or nuclei are optionally passed through the strain chamber where cell debris are strained out.

39. The method of embodiment 38, wherein recovering cells and/or nuclei comprises introducing cell and/or nuclei storage buffer into the post-processing chamber to create a suspension, dis-engaging the cartridge from the instrument, and removing the suspension from the post-processing chamber.

40. The method of embodiment 39, wherein the post-processing chamber comprises a port communicating through a fluidic channel to a reagent module in the instrument, and the method comprises moving liquid from the reagent module into the post-processing chamber.

41. The method of embodiment 35, wherein mechanically disrupting comprises introducing a solution comprising one or more enzymes and/or one or more detergents from the reagent module into the processing chamber.

42. The method of embodiment 28 or embodiment 35, wherein removing one or more of the solutions from the processing chamber comprises applying negative pressure to the vacuum port.

43. The method of embodiment 38, further comprising measuring, at one or more time points, one or more characteristics of a sample in the post-processing chamber.

44. The method of embodiment 43, wherein the characteristic is selected from the degree of cell or nuclei dissociation or the titer of cells or nuclei or the intensity of staining.

45. A cartridge comprising:
(i) a processing chamber;
wherein the processing chamber comprises a floor, a side wall, and a top orifice, first and second processing chamber ports positioned in the side wall, and a third processing chamber port positioned in the floor;
(ii) a rotor assembly comprising a cap and a plunger,
wherein the cap is positioned in the orifice;
wherein the plunger comprises a piston and a distal rotor and is slidably positioned in the processing chamber through the cap;
(iii) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE tor OCT issue sample); or
(B) an assembly comprising a basket and a lid (218), wherein the basket has an open top that is closed by the lid, and the lid comprises the rotor;
(iv) a strain chamber comprising a first strainer having pores no greater than about 70 microns, and an optional second strainer having pores no greater than about 200 microns;
wherein the strain chamber communicates with the processing chamber through the second processing port;
(v) a waste port that communicates with the third processing chamber port;
(vi) a post-processing chamber comprising:
a first post-processing chamber port that communicates with the strain chamber; and
a second post-processing chamber port; and
a third post-processing chamber port; and
(vii) a vacuum trap comprising:
a first vacuum trap port that communicates with the post-processing chamber through the second post-processing chamber port; and
a second vacuum trap chamber port.

46. The cartridge of embodiment 45, wherein the processing chamber and the post-processing chamber communicate through a fluidic channel.

47. The cartridge of embodiment 45, wherein the third processing chamber port and the waste port communicate through a fluidic channel.

48. The cartridge of embodiment 45, wherein the porous container comprises a mesh (2320/2330).

49. The cartridge of embodiment 46, wherein the mesh has holes no greater than any of 500 microns, 400 microns, 300 microns, 250 microns, 200 microns, 150 microns, 100 microns, 75 microns, 50 microns, 25 microns, 20 microns, 10 microns, 5 microns, 2 microns, 1 microns, or 0.5 microns.

50. The cartridge of embodiment 45, wherein the upper portion is attached to the lower portion, e.g., through a hinge (2310).

51. The cartridge of embodiment 45, wherein the ring comprises a snap for closing the ring.

52. The cartridge of embodiment 45, wherein the upper portion and lower portion close by magnetic attraction.

53. The cartridge of embodiment 45, wherein the basket is attached to the plunger via a hinge.

54. The cartridge of embodiment 45, wherein the basket is closed by a magnet or a clasp.

55. The cartridge of embodiment 45, wherein the lid seals the basket through an “o” ring.

56. The cartridge of embodiment 45, wherein the basket comprises a mesh, e.g., a nylon mesh.

57. The cartridge of embodiment 45, wherein the first strainer has pores no more than about 40 microns (e.g., no greater than about 20 microns) and the second strainer has pores between about 140 microns to about 200 microns.

58. The cartridge of embodiment 45, wherein the first strainer has pores about 145 microns, the second strainer has pores between about 40 microns and a third filter has pores of about 20 microns.

59. The cartridge of embodiment 45, wherein the second processing port communicates with the post-processing chamber through a port in a cap of the post-processing chamber.

60. The cartridge of embodiment 45, wherein of embodiment 30, wherein the rotor of the plunger is biased toward the cap (e.g., spring biased).

61. The cartridge of embodiment 45, wherein of embodiment 30, wherein the rotor has sufficient clearance from the processing chamber walls to allow liquid, cells and nuclei to pass around the rotor during depression, and the first processing port is positioned above the rotor when fully depressed.

62. The cartridge of embodiment 45, wherein the porous container is configured as an assembly comprising a basket and a lid, wherein the basket has an open top that is closed by the lid, the lid is attached to the plunger, wherein the assembly fits into the processing chamber, and wherein moving the plunger up and down along the Z axis moves the basket up and down through the solution.

63. The cartridge of embodiment 45, wherein the second processing port is covered by a filter, e.g., a dual filter, having pores too small for cells and/or nuclei to pass.

64. The cartridge of embodiment 45, wherein the second processing port communicates with the post-processing chamber through a port in a cap of the post-processing chamber.

65. The cartridge of embodiment 45, wherein processing chamber, the post-processing chamber and the waste chamber communicate through fluidic channels that meet at a three-way junction and have one or more switchable valves.

66. The cartridge of embodiment 45, comprising a valve between the processing chamber and the post-processing chamber and between the vacuum chamber and either or both of the processing chamber and the post-processing chamber.

67. The cartridge of embodiment 45, further comprising a detection window.

68. The cartridge of embodiment 45, further comprising a waste chamber comprising a first waste chamber port that communicates with the processing chamber.

69. A system comprising:
(a) an instrument comprising:
(i) a cartridge interface configured to engage a cartridge;
(ii) a fluidic subsystem comprising:
(1) one or more fluid lines connecting the one or more containers with one or more fluid ports in the cartridge interface; and
(2) one or more pumps configured to apply positive or negative pressure to one or more fluid ports and to move liquids and/or gasses into and/or out of the one or more fluid ports
(3) an optional waste chamber communicating with a pump;
(iii) a physical dissociation subsystem comprising an actuator, a linear driver (e.g., a stepper motor or a pneumatic driver) that drives an actuator in an up-down (Z axis) direction, and a rotary motor that rotates the actuator around the Z axis; and
(v) a control subsystem comprising a digital computer comprising a processor and memory, wherein the memory comprises code that, when executed by the processor, instructs the system to perform one or more operations;
(b) an enzymatic and chemical dissociation subsystem, which may be positioned inside or outside of the instrument, comprising:
(1) a reagent module comprising one or more containers containing one or more liquids and/or gasses and/or solids; and
(c) a cartridge of any of embodiments 45 to 67, releasably engaged with the cartridge interface, wherein:
(A) the first processing port is engaged with a first interface port in the cartridge interface that is connected with a pump that delivers reagents from the reagent module to the first cartridge port;
(B) the rotor assembly is engaged with the actuator;
(C) the waste port is engaged with a second interface port in the cartridge interface that is connected with a pump that positive or negative pressure to the waste port;
(D) the third post-processing chamber port is engaged with a third interface port in the cartridge interface that is connected with a pump that delivers reagents from the reagent module to the third post-processing port;
(E) the second vacuum trap port is engaged with a fourth interface port in the cartridge interface that is connected with a pump that positive or negative pressure to the waste port; wherein the operations comprise introducing fluids from the reagent module into the processing chamber, introducing fluids from the reagent module into the post-processing chamber; stepping and/or rotating the rotor assembly, moving liquid from the processing chamber through the cartridge waste port, and moving a suspension from the processing chamber to the post-processing chamber.

70. The system of embodiment 69, wherein the interface ports comprise fittings that engage the cartridge ports (e.g., nozzles, pogo pins, a flared connectors).

71. The system of embodiment 69, wherein the control subsystem comprises a user interface configured to accept input from a user in the execution of the instructions.

72. The system of embodiment 69, wherein the instrument further comprises one or more of:
(vi) a magnetic post-processing module comprising a source of magnetic force, wherein the magnetic force is positioned to form a magnetic field in the post-processing chamber;
(vii) a measurement subsystem that performs optical imaging to measure titer, clumping, and/or viability of cells or nuclei or other characteristics of the sample in the cartridge; and
(viii) a temperature control subsystem comprising a heating and/or cooling element positioned to heat and/or cool the processing chamber and/or the post-processing chamber.

73. The system of embodiment 72, wherein the measurement subsystem is configured to measure, at one or more time points, characteristics of a sample in the post-processing chamber.

74. The system of embodiment 73, wherein the characteristic is selected from viability or degree of cell or nuclei dissociation or cell type or cell surface markers.

75. The system of embodiment 73, wherein the characteristic is selected from degree of deparaffinization or rehydration.

76. The system of embodiment 72, wherein the temperature control subsystem comprises a thermal transfer plate and a temperature controller, e.g., a Peltier, a strip resistive heater, one or more circulating fluids.

77. The system of embodiment 69, wherein the containers contain one or more of: a deparaffinizing solution, a cross-link reversal solution, one or more rehydrating solutions, protease solutions, a buffer comprising a detergent, a lysis buffer, a resuspension buffer, dissociation solution, nuclei isolation solution, and nuclei storage solution.

78. The system of embodiment 77, wherein the deparaffinizing solution comprises a compound that dissolves paraffin, e.g., xylene.

79. The system of embodiment 77, wherein the rehydrating solutions are selected from H2O and aqueous solutions of ethanol of different concentrations.

80. The system of embodiment 77, wherein the protease solutions comprise one or more of proteinase K, a collagenase (e.g., collagenases type I, II, III, IV, and others), elastase, trypsin, papain, hyaluronidase, chymotrypsin, neutral protease, clostripain, caseinase, and neutral protease (Dispase®),

81. The system of embodiment 77, wherein the lysis buffer comprises an aqueous buffer and a detergent.

82. The system of embodiment 77, wherein the resuspension buffer comprises an aqueous buffer, and a compound for maintaining osmolarity compatible with cells and/or nuclei, e.g., bovine serum albumin.

83. The system of embodiment 77, wherein the dissociation solution comprises one or more enzymes that cleave extracellular matrix.

84. The system of embodiment 77, wherein the cross-link reversal solution comprises an enzyme or chemical that cleaves formalin cross-links, e.g., Proteinase K or IHC retrieval reagent.

85. The system of embodiment 77, wherein the nuclei isolation solution comprises a buffer compatible with nuclei.

86. The system of embodiment 77, wherein the nuclei storage solution comprises an aqueous buffer, a salt, and Ca++ and/or Mg++.

87. The system of embodiment 69, wherein one of the pumps provides vacuum to a fluid port engaging the second vacuum trap port.

88. The system of embodiment 69, wherein the actuator engages the rotor assembly through a drive fitting, e.g., slot, cross, phillips, polygon, or interlocking teeth.

89. The system of embodiment 69, further comprising a barcode reader.

90. The system of embodiment 69, further comprising:
(c) an analysis subsystem, wherein an input port of the analysis module communicates with the post-processing chamber.

91. The system of embodiment 90, wherein the analysis system communicates with the post-processing chamber through a fluidic channel or fluid handling robot.

92. The system of embodiment 90, wherein the analysis module performs an analysis selected from one or more of DNA sequencing, next generation DNA sequencing, next generation DNA sequencing, proteomic analysis, genomic analysis, gene expression analysis, gene mapping, carbohydrate characterization and profiling, lipid characterization and profiling, flow cytometry, imaging, DNA or RNA microarray analysis, metabolic profiling, enzymatic assays, functional analysis, and mass spectrometry

93. A kit comprising:
(i) a processing chamber;
wherein the processing chamber comprises a floor, a side wall, and a top orifice, first and second processing chamber ports positioned in the side wall, and a third processing chamber port positioned in the floor;
(ii) a strain chamber comprising a strainer having pores no greater than about 40 microns (e.g., no greater than about 20 microns), and an optional second strainer having pores no greater than about 200 microns;
wherein the strain chamber communicates with the processing chamber through the second processing port;
(iii) a waste port that communicates with the third processing chamber port;
(iv) a post-processing chamber comprising.
a first post-processing chamber port that communicates with the strain chamber, and
a second post-processing chamber port; and
a third post-processing chamber port, and
(v) a vacuum trap comprising:
a first vacuum trap port that communicates with the post-processing chamber through the second post-processing chamber port, and
a second vacuum trap chamber port.
(b) a rotor assembly comprising a cap and a plunger,
wherein the plunger comprises a piston and a distal rotor and is slidably positioned through the cap;
(c) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE or OCT or other tissue samples); or
(B) an assembly comprising a basket and a lid, wherein the basket has an open top that is closed by the lid, and the lid comprises the rotor.

94. The kit of embodiment 93, further comprising one or more containers, wherein the containers contain one or more of: a deparaffinizing solution, one or more rehydrating solutions, one or more rinse solutions, protease solutions, a buffer comprising a detergent, a lysis buffer, a resuspension buffer, dissociation solution, nuclei isolation solution, and nuclei storage solution.

95. An article comprising a cap, and rotor assembly comprising a piston and a distal rotor, wherein the rotor reversibly closes a basket attached thereto, and wherein the piston is slidably inserted through the cap.

96. A method comprising operating the system of any of embodiments 69 to 91, to isolate cells and/or nuclei from tissue.

97. The method of embodiment 96, wherein the tissue comprises fresh frozen tissue, formalin fixed paraffin embedded tissue, or optimal cutting temperature (“OCT”) tissue.

As used herein, the following meanings apply unless otherwise specified. The word “may” is used in a permissive sense (i.e., meaning having the potential to), rather than the mandatory sense (i.e., meaning must). The words “include”, “including”, and “includes” and the like mean including, but not limited to. The singular forms “a,” “an,” and “the” include plural referents. Thus, for example, reference to “an element” includes a combination of two or more elements, notwithstanding use of other terms and phrases for one or more elements, such as “one or more.” The term “or” is, unless indicated otherwise, non-exclusive, i.e., encompassing both “and” and “or.”

As used herein, the terms “comprises,” “comprising,” “includes,” “including,” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Both plural and singular means may be included. The term “any of” between a modifier and a sequence means that the modifier modifies each member of the sequence. So, for example, the phrase “at least any of 1, 2 or 3” means “at least 1, at least 2 or at least 3”. The term “consisting essentially of” refers to the inclusion of recited elements and other elements that do not materially affect the basic and novel characteristics of a claimed combination.

All patents, patent applications, published applications, treatises and other publications referred to herein, both supra and infra, are incorporated by reference in their entirety. If a definition and/or description is set forth herein that is contrary to or otherwise inconsistent with any definition set forth in the patents, patent applications, published applications, and other publications that are herein incorporated by reference, the definition and/or description set forth herein prevails over the definition that is incorporated by reference.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

What is claimed is:

1. A method of processing preserved tissue, comprising:
a) providing a sample of preserved tissue in a closed, porous container that allows liquid flow through the pores;
b) inserting the container with preserved tissue into a processing chamber of a cartridge and engaging the cartridge with an instrument;
c) processing the tissue to remove preservative compounds by introducing, one or more times, a processing solution from the instrument into the processing chamber, to produce processed tissue, and removing processing solutions from the processing chamber.

2. The method of claim 1, wherein the preserved tissue comprises formalin fixed paraffin-embedded (“FFPE”) tissue, wherein processing comprises:
deparaffinizing the tissue by introducing, one or more times, a deparaffinizing solution from the instrument into the processing chamber, to produce de-paraffinized tissue, and removing deparaffinizing solutions from the processing chamber; and
re-hydrating the deparaffinized tissue by introducing one or more re-hydrating solutions from the instrument into the processing chamber, to produce rehydrated tissue, and removing the rehydrating solutions from the processing chamber; and
optionally, reversing crosslinks in the rehydrated tissue by heating the processing chamber, applying ultrasonic energy to the processing chamber, or introducing one or more enzymes or chemicals from the instrument into the processing chamber, to produce un-crosslinked tissue, and removing the enzymes or chemicals from the processing chamber; and
optionally, recovering the processed tissue from the container.

3. The method of claim 1, wherein the preserved tissue comprises optimal cutting temperature (“OCT”) tissue, wherein processing comprises:
removing OCT compounds by introducing, one or more times, one or more rinse reagents from the instrument into the processing chamber, to produce processed tissue, and removing rinse reagents from the processing chamber, and
optionally, recovering the rinsed tissue from the container

4. The method of any of the preceding claims, further comprising:
releasing cells and/or nuclei from the processed tissue mechanically and/or enzymatically or chemically in the processing chamber.

5. The method of claim 4, further comprising:
separating the cells and/or nuclei from debris or aggregates by passing the released cells and/or nuclei from the processing chamber through a strain chamber comprising a strainer and into a processing chamber.

6. The method of claim 5, comprising recovering cells from the processing chamber.

7. The method of claim 5, comprising recovering nuclei from the processing chamber.

8. The method of claim 4, wherein releasing cells and/or nuclei from the tissue comprises:
placing the recovered tissue into processing chamber;
introducing a mechanical tissue disruptor into the processing chamber; and mechanically disrupting the tissue to release cells and/or nuclei.

9. The method of claim 4, wherein releasing cells and/or nuclei from the tissue comprises:
mechanically deforming the porous container in the processing chamber.

10. The method of claim 4, wherein releasing cells and/or nuclei from the tissue comprises:
introducing enzymes and/or chemicals into the processing chamber to disrupt extracellular matrix.

11. The method of claim 1, wherein the porous container is configured as a ring having an upper portion and a lower portion which, when mated, define a space for receiving an FFPE tissue sample.

12. The method of claim 11, wherein the porous container comprises a mesh.

13. The method of claim 11, wherein the upper portion is attached to the lower portion, e.g., through a hinge.

14. The method of claim 11, wherein the ring comprises a snap for closing the ring.

15. The method of claim 11, wherein the upper portion and lower portion close by magnetic attraction.

16. The method of claim 1, wherein the porous container is configured as an assembly comprising a basket and a lid, wherein the basket has an open top that is closed by the lid, the lid is attached to a plunger, wherein the assembly fits into the processing chamber.

17. The method of claim 16, wherein the basket is attached to the plunger via a hinge.

18. The method of claim 16, wherein the assembly is closed by a magnet or a clasp.

19. The method of claim 16, wherein the cap seals the basket through an “o” ring.

20. The method of claim 16, wherein the basket comprises a mesh, e.g., a nylon mesh.

21. The method of claim 12 or claim 20, wherein the mesh has perforations no greater than any of 500 microns, 400 microns, 300 microns, 250 microns, 200 microns, 150 microns, 100 microns, 75 microns, 50 microns, 25 microns, 20 microns, 10 microns, 5 microns, 2 microns, 1 microns, or 0.5 microns.

22. The method of any of claims 1-10, wherein the enzymes or chemicals comprise one or more of a protease, a collagenase, a hyaluronidase, an elastase, an osmoprotectant, a DNase, a protease inhibitor, a nuclease inhibitor, a detergent, and a buffer.

23. The method of claim 1, wherein the deparaffinizing solution comprises xylene, xylol, or histolene.

24. The method of claim 1, wherein deparaffinizing comprises regulating temperature of the processing chamber.

25. The method of claim 1, wherein the one or more re-hydrating solutions comprise aqueous solutions of ethanol at decreasing concentrations, and/or H₂O.

26. The method of claim 1, wherein the tissue is not mounted on a slide.

27. The method of any of the foregoing claims, wherein the cartridge comprises:
(i) a processing chamber;
wherein the processing chamber comprises a floor, a side wall, and a top orifice, first and second processing chamber ports positioned in the side wall, and a third processing chamber port positioned in the floor;
(ii) a rotor assembly comprising a cap and a plunger,
wherein the cap is positioned in the orifice;
wherein the plunger comprises a piston and a distal rotor and is slidably positioned in the processing chamber through the cap;
(iii) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE or OCT tissue sample); or
(B) an assembly comprising a basket and a lid, wherein the basket has an open top that is closed by the lid, and the lid comprises the rotor:
(iv) a strain chamber comprising a strainer having pores no greater than about 40 microns (e.g., no greater than about 20 microns), and an optional second strainer having pores no greater than about 200 microns:
wherein the strain chamber communicates with the processing chamber through the second processing port;
(v) a waste port that communicates with the third processing chamber port;
(vi) a post-processing chamber comprising:
a first post-processing chamber port that communicates with the strain chamber; and
a second post-processing chamber port; and
a third post-processing chamber port; and
(vii) a vacuum trap comprising:
a first vacuum trap port that communicates with the post-processing chamber through the second post-processing chamber port; and
a second vacuum trap chamber port.

28. The method of claim 27, wherein the rotor of the plunger is biased toward the cap (e.g., spring biased).

29. The method of claim 27,
wherein deparaffinizing comprises:
(i) introducing the deparaffinizing solution into the processing chamber through the first processing port from a chamber in the reagent module; and
(ii) removing the deparaffinizing solution from the processing chamber through the processing third port;
wherein re-hydrating comprises:
(i) introducing the re-hydrating solutions into the processing chamber through the first processing port from one or more chambers in the reagent module; and
(ii) removing the re-hydrating solutions from the processing chamber through the third processing port; and
wherein optionally reversing crosslinks in the rehydrated tissue comprises:
(i) introducing an enzyme solution comprising the one or more enzymes into the processing chamber through the first processing port from one or more chambers in the reagent module; and
(ii) removing the one or more enzymes from the processing chamber through the third processing port.

30. The method of claim 29, further comprising mixing the solutions in the processing chamber by moving the plunger up and down along a Z axis and/or rotating the plunger around the Z axis, in the processing chamber.

31. The method of claim 29, wherein the second processing port communicates with the post-processing chamber through a port in a cap of the post-processing chamber.

32. The method of claim 31, wherein the rotor has sufficient clearance from the processing chamber walls to allow liquid, cells and nuclei to pass around the rotor during depression, the second processing port is positioned above the rotor when fully depressed, and removing solution comprises depressing the rotor and applying negative pressure to the vacuum port.

33. The method of claim 29, wherein the porous container is configured as an assembly comprising a basket and a lid, wherein the basket has an open top that is closed by the lid, the lid is attached to the plunger, wherein the assembly fits into the processing chamber, and wherein moving the plunger up and down along the Z axis moves the basket up and down through the solution.

34. The method of claim 27,
wherein removing OCT compounds comprises:
(i) introducing, one or more times, rinsing reagents into the processing chamber through the first processing port from a chamber in the reagent module; and
(ii) removing the rinsing reagents from the processing chamber through the processing third port.

35. The method of method of claim 27, wherein mechanically disrupting comprises:
(i) introducing a disruption solution into the processing chamber through the first processing port from a chamber in the reagent module; and
(ii) grinding the tissue recovered from the porous container against the floor by moving the plunger up and down along a Z axis and/or rotating the plunger around the Z axis, in the processing chamber.

36. The method of method of claim 27, wherein mechanically disrupting comprises:
(i) introducing a disruption solution into the processing chamber through the first processing port from a chamber in the reagent module; and
(ii) deforming the porous container containing the tissue with the plunger to disrupt the tissue.

37. The method of method of claim 27, wherein mechanically disrupting comprises:
(i) introducing a disruption solution into the processing chamber through the first processing port from a chamber in the reagent module; and
(ii) rotating and moving up and down, the assembly comprising the basket in the disruption solution.

38. The method of claim 35, wherein recovering the cells and/or nuclei comprises moving released cells and/or nuclei from the processing chamber, through the second processing port, through the fluidic channel and into the post-processing chamber; wherein the cells and/or nuclei are optionally passed through the strain chamber where cell debris are strained out.

39. The method of claim 38, wherein recovering cells and/or nuclei comprises introducing cell and/or nuclei storage buffer into the post-processing chamber to create a suspension, dis-engaging the cartridge from the instrument, and removing the suspension from the post-processing chamber.

40. The method of claim 39, wherein the post-processing chamber comprises a port communicating through a fluidic channel to a reagent module in the instrument, and the method comprises moving liquid from the reagent module into the post-processing chamber.

41. The method of claim 35, wherein mechanically disrupting comprises introducing a solution comprising one or more enzymes and/or one or more detergents from the reagent module into the processing chamber.

42. The method of claim 28 or claim 35, wherein removing one or more of the solutions from the processing chamber comprises applying negative pressure to the vacuum port.

43. The method of claim 38, further comprising measuring, at one or more time points, one or more characteristics of a sample in the post-processing chamber.

44. The method of claim 43, wherein the characteristic is selected from the degree of cell or nuclei dissociation or the titer of cells or nuclei or the intensity of staining.

45. A cartridge comprising:
(i) a processing chamber;
wherein the processing chamber comprises a floor, a side wall, and a top orifice, first and second processing chamber ports positioned in the side wall, and a third processing chamber port positioned in the floor;
(ii) a rotor assembly comprising a cap and a plunger,
wherein the cap is positioned in the orifice;
wherein the plunger comprises a piston and a distal rotor and is slidably positioned in the processing chamber through the cap;
(iii) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE tor OCT issue sample), or
(B) an assembly comprising a basket and a lid (218), wherein the basket has an open top that is closed by the lid, and the lid comprises the rotor;
(iv) a strain chamber comprising a first strainer having pores no greater than about 70 microns, and an optional second strainer having pores no greater than about 200 microns;
wherein the strain chamber communicates with the processing chamber through the second processing port;
(v) a waste port that communicates with the third processing chamber port;
(vi) a post-processing chamber comprising:
a first post-processing chamber port that communicates with the strain chamber; and
a second post-processing chamber port; and
a third post-processing chamber port; and
(vii) a vacuum trap comprising:
a first vacuum trap port that communicates with the post-processing chamber through the second post-processing chamber port; and
a second vacuum trap chamber port.

46. The cartridge of claim 45, wherein the processing chamber and the post-processing chamber communicate through a fluidic channel.

47. The cartridge of claim 45, wherein the third processing chamber port and the waste port communicate through a fluidic channel.

48. The cartridge of claim 45, wherein the porous container comprises a mesh (2320/2330).

49. The cartridge of claim 46, wherein the mesh has holes no greater than any of 500 microns, 400 microns, 300 microns, 250 microns, 200 microns, 150 microns, 100 microns, 75 microns, 50 microns, 25 microns, 20 microns, 10 microns, 5 microns, 2 microns, 1 microns, or 0.5 microns.

50. The cartridge of claim 45, wherein the upper portion is attached to the lower portion, e.g., through a hinge (2310).

51. The cartridge of claim 45, wherein the ring comprises a snap for closing the ring.

52. The cartridge of claim 45, wherein the upper portion and lower portion close by magnetic attraction.

53. The cartridge of claim 45, wherein the basket is attached to the plunger via a hinge.

54. The cartridge of claim 45, wherein the basket is closed by a magnet or a clasp.

55. The cartridge of claim 45, wherein the lid seals the basket through an “o” ring.

56. The cartridge of claim 45, wherein the basket comprises a mesh, e.g., a nylon mesh.

57. The cartridge of claim 45, wherein the first strainer has pores no more than about 40 microns (e.g., no greater than about 20 microns) and the second strainer has pores between about 140 microns to about 200 microns.

58. The cartridge of claim 45, wherein the first strainer has pores about 145 microns, the second strainer has pores between about 40 microns and a third filter has pores of about 20 microns.

59. The cartridge of claim 45, wherein the second processing port communicates with the post-processing chamber through a port in a cap of the post-processing chamber.

60. The cartridge of claim 45, wherein of claim 30, wherein the rotor of the plunger is biased toward the cap (e.g., spring biased).

61. The cartridge of claim 45, wherein of claim 30, wherein the rotor has sufficient clearance from the processing chamber walls to allow liquid, cells and nuclei to pass around the rotor during depression, and the first processing port is positioned above the rotor when fully depressed.

62. The cartridge of claim 45, wherein the porous container is configured as an assembly comprising a basket and a lid, wherein the basket has an open top that is closed by the lid, the lid is attached to the plunger, wherein the assembly fits into the processing chamber, and wherein moving the plunger up and down along the Z axis moves the basket up and down through the solution.

63. The cartridge of claim 45, wherein the second processing port is covered by a filter, e.g., a dual filter, having pores too small for cells and/or nuclei to pass.

64. The cartridge of claim 45, wherein the second processing port communicates with the post-processing chamber through a port in a cap of the post-processing chamber.

65. The cartridge of claim 45, wherein processing chamber, the post-processing chamber and the waste chamber communicate through fluidic channels that meet at a three-way junction and have one or more switchable valves.

66. The cartridge of claim 45, comprising a valve between the processing chamber and the post-processing chamber and between the vacuum chamber and either or both of the processing chamber and the post-processing chamber.

67. The cartridge of claim 45, further comprising a detection window.

68. The cartridge of claim 45, further comprising a waste chamber comprising a first waste chamber port that communicates with the processing chamber.

69. A system comprising:
(a) an instrument comprising:
(i) a cartridge interface configured to engage a cartridge;
(ii) a fluidic subsystem comprising:
(1) one or more fluid lines connecting the one or more containers with one or more fluid ports in the cartridge interface; and
(2) one or more pumps configured to apply positive or negative pressure to one or more fluid ports and to move liquids and/or gasses into and/or out of the one or more fluid ports
(3) an optional waste chamber communicating with a pump:
(iii) a physical dissociation subsystem comprising an actuator, a linear driver (e.g., a stepper motor or a pneumatic driver) that drives an actuator in an up-down (Z axis) direction, and a rotary motor that rotates the actuator around the Z axis; and
(v) a control subsystem comprising a digital computer comprising a processor and memory, wherein the memory comprises code that, when executed by the processor, instructs the system to perform one or more operations;
(b) an enzymatic and chemical dissociation subsystem, which may be positioned inside or outside of the instrument, comprising:
(1) a reagent module comprising one or more containers containing one or more liquids and/or gasses and/or solids; and
(c) a cartridge of any of claims 45 to 67, releasably engaged with the cartridge interface, wherein:
(A) the first processing port is engaged with a first interface port in the cartridge interface that is connected with a pump that delivers reagents from the reagent module to the first cartridge port;
(B) the rotor assembly is engaged with the actuator;
(C) the waste port is engaged with a second interface port in the cartridge interface that is connected with a pump that positive or negative pressure to the waste port;
(D) the third post-processing chamber port is engaged with a third interface port in the cartridge interface that is connected with a pump that delivers reagents from the reagent module to the third post-processing port;
(E) the second vacuum trap port is engaged with a fourth interface port in the cartridge interface that is connected with a pump that positive or negative pressure to the waste port;
wherein the operations comprise introducing fluids from the reagent module into the processing chamber, introducing fluids from the reagent module into the post-processing chamber; stepping and/or rotating the rotor assembly, moving liquid from the processing chamber through the cartridge waste port, and moving a suspension from the processing chamber to the post-processing chamber.

70. The system of claim 69, wherein the interface ports comprise fittings that engage the cartridge ports (e.g., nozzles, pogo pins, a flared connectors).

71. The system of claim 69, wherein the control subsystem comprises a user interface configured to accept input from a user in the execution of the instructions.

72. The system of claim 69, wherein the instrument further comprises one or more of:
(vi) a magnetic post-processing module comprising a source of magnetic force, wherein the magnetic force is positioned to form a magnetic field in the post-processing chamber;
(vii) a measurement subsystem that performs optical imaging to measure titer, clumping, and/or viability of cells or nuclei or other characteristics of the sample in the cartridge; and
(viii) a temperature control subsystem comprising a heating and/or cooling element positioned to heat and/or cool the processing chamber and/or the post-processing chamber.

73. The system of claim 72, wherein the measurement subsystem is configured to measure, at one or more time points, characteristics of a sample in the post-processing chamber.

74. The system of claim 73, wherein the characteristic is selected from viability or degree of cell or nuclei dissociation or cell type or cell surface markers.

75. The system of claim 73, wherein the characteristic is selected from degree of deparaffinization or rehydration.

76. The system of claim 72, wherein the temperature control subsystem comprises a thermal transfer plate and a temperature controller, e.g., a Peltier, a strip resistive heater, one or more circulating fluids.

77. The system of claim 69, wherein the containers contain one or more of: a deparaffinizing solution, a cross-link reversal solution, one or more rehydrating solutions, protease solutions, a buffer comprising a detergent, a lysis buffer, a resuspension buffer, dissociation solution, nuclei isolation solution, and nuclei storage solution.

78. The system of claim 77, wherein the deparaffinizing solution comprises a compound that dissolves paraffin, e.g., xylene.

79. The system of claim 77, wherein the rehydrating solutions are selected from H₂O and aqueous solutions of ethanol of different concentrations.

80. The system of claim 77, wherein the protease solutions comprise one or more of proteinase K, a collagenase (e.g., collagenases type I, II, III, IV, and others), elastase, trypsin, papain, hyaluronidase, chymotrypsin, neutral protease, clostripain, caseinase, and neutral protease (Dispase®).

81. The system of claim 77, wherein the lysis buffer comprises an aqueous buffer and a detergent.

82. The system of claim 77, wherein the resuspension buffer comprises an aqueous buffer, and a compound for maintaining osmolarity compatible with cells and/or nuclei, e.g., bovine serum albumin.

83. The system of claim 77, wherein the dissociation solution comprises one or more enzymes that cleave extracellular matrix.

84. The system of claim 77, wherein the cross-link reversal solution comprises an enzyme or chemical that cleaves formalin cross-links, e.g., Proteinase K or IHC retrieval reagent.

85. The system of claim 77, wherein the nuclei isolation solution comprises a buffer compatible with nuclei.

86. The system of claim 77, wherein the nuclei storage solution comprises an aqueous buffer, a salt, and Ca⁺⁺ and/or Mg⁺⁺.

87. The system of claim 69, wherein one of the pumps provides vacuum to a fluid port engaging the second vacuum trap port.

88. The system of claim 69, wherein the actuator engages the rotor assembly through a drive fitting, e.g., slot, cross, phillips, polygon, or interlocking teeth.

89. The system of claim 69, further comprising a barcode reader.

90. The system of claim 69, further comprising:
(c) an analysis subsystem, wherein an input port of the analysis module communicates with the post-processing chamber.

91. The system of claim 90, wherein the analysis system communicates with the post-processing chamber through a fluidic channel or fluid handling robot.

92. The system of claim 90, wherein the analysis module performs an analysis selected from one or more of: DNA sequencing, next generation DNA sequencing, next generation DNA sequencing, proteomic analysis, genomic analysis, gene expression analysis, gene mapping, carbohydrate characterization and profiling, lipid characterization and profiling, flow cytometry, imaging, DNA or RNA microarray analysis, metabolic profiling, enzymatic assays, functional analysis, and mass spectrometry.

93. A kit comprising:
(i) a processing chamber;
wherein the processing chamber comprises a floor, a side wall, and a top orifice, first and second processing chamber ports positioned in the side wall, and a third processing chamber port positioned in the floor;
(ii) a strain chamber comprising a strainer having pores no greater than about 40 microns (e.g., no greater than about 20 microns), and an optional second strainer having pores no greater than about 200 microns;
wherein the strain chamber communicates with the processing chamber through the second processing port;
(iii) a waste port that communicates with the third processing chamber port;
(iv) a post-processing chamber comprising:
a first post-processing chamber port that communicates with the strain chamber; and
a second post-processing chamber port; and
a third post-processing chamber port; and
(v) a vacuum trap comprising:
a first vacuum trap port that communicates with the post-processing chamber through the second post-processing chamber port; and
a second vacuum trap chamber port,
(b) a rotor assembly comprising a cap and a plunger,
wherein the plunger comprises a piston and a distal rotor and is slidably positioned through the cap;
(c) a reversibly closable, porous container positioned in the processing chamber, wherein perforations allow liquid to flow into and out of the porous container;
wherein the porous container is configured as:
(A) a free, circular container (e.g., a ring) having an upper portion and a lower portion which, when mated, define a space for receiving one or more tissue samples (e.g., FFPE or OCT or other tissue samples); or
(B) an assembly comprising a basket and a lid, wherein the basket has an open top that is closed by the lid, and the lid comprises the rotor.

94. The kit of claim 93, further comprising one or more containers, wherein the containers contain one or more of: a deparaffinizing solution, one or more rehydrating solutions, one or more rinse solutions, protease solutions, a buffer comprising a detergent, a lysis buffer, a resuspension buffer, dissociation solution, nuclei isolation solution, and nuclei storage solution.

95. An article comprising a cap, and rotor assembly comprising a piston and a distal rotor, wherein the rotor reversibly closes a basket attached thereto, and wherein the piston is slidably inserted through the cap.

96. A method comprising operating the system of any of claims 69 to 91, to isolate cells and/or nuclei from tissue.

97. The method of claim 96, wherein the tissue comprises fresh frozen tissue, formalin fixed paraffin embedded tissue, or optimal cutting temperature (“OCT”) tissue.
